(19) United States
(12) Patent Application Publication
(10) Pub. No.: US 2026/0189552 A1
(43) Pub. Date: Jul. 2, 2026

(54) SYSTEMS AND METHODS THAT PROVIDE A HIGH LEVEL OF SECURITY FOR A USER

(71) Applicant: Orchid Authentication Systems Inc., Wilmington, DE (US)

(72) Inventors: John N. Irwin, III, Greenwich, CT (US); R. Maxwell Flaherty, Topsfield, MA (US); J. Christopher Flaherty, Nottingham, NH (US)

(21) Appl. No.: 18/872,381

(22) PCT Filed: Jun. 13, 2023
(86) PCT No.: PCT/US2023/025196

§ 371 Date: Dec. 6, 2024

Related U.S. Application Data
(60) Provisional application No. 63/351,635, filed on Jun. 13, 2022.

(51) Int. Cl. H04L 9/40

(52) U.S. Cl. CPC H04L 63/0861

(57) ABSTRACT

Systems, methods, and software products provide increased trust in authentication of a user to an authentication server when a trusted witness client device witnesses the authentication of the user on the user's root client device. Both the root and the witness client devices cooperate to present the user with an interactive task during the authentications and each client device independently captures movement of the user performing the interactive task, during which, the user is authenticated to the root client device. An increased level of trust in the authentication of the user is achieved by the authentication server when the captured movements match expected movements of the user performing the interactive task and the authentication server has proof that the witness client device witnessed a successful authentication.

### RELATED APPLICATIONS

The present application claims priority to U.S. Provisional Patent Application Ser. No. 63/351,635 (Docket No. ORC-009-PR1), titled “Systems and Methods That Provide a High Level of Security for a User” Authentication Witness Systems and Methods”, filed Jun. 13, 2022, the content of which is incorporated herein by reference in its entirety for all purposes.

This application is related to U.S. Provisional Application Ser. No. 62/753,305, (Docket No. ORC-006-PR), titled “Passwordless Authentication”, filed Oct. 31, 2018, the content of which is incorporated by reference in its entirety for all purposes.

This application is related to International PCT Patent Application Serial Number PCT/US19/059248, (Docket No. ORC-006-PCT), titled “Passwordless Authentication Systems and Methods” filed Oct. 31, 2019, Publication Number WO 2020/092832, published May 7, 2020, the content of which is incorporated by reference in its entirety for all purposes.

This application is related to U.S. National Stage application Ser. No. 17/290,740, (Docket No. ORC-006-US), titled “Passwordless Authentication Systems and Methods”, filed Dec. 10, 2021, Publication Number US 2022/0004617, published Jan. 6, 2022, the content of which is incorporated by reference in its entirety for all purposes.

This application is related to U.S. Provisional Patent Application Ser. No. 63/123,950 (Docket No. ORC-007-PR1), titled “Authentication Witness Systems and Methods”, filed Dec. 10, 2020, the content of which is incorporated herein by reference in its entirety for all purposes.

This application is related to International PCT Patent Application Serial Number PCT/US21/062809, (Docket No. ORC-007-PCT), titled “Systems and Methods Including User Authentication”, filed Dec. 10, 2021, Publication Number WO2022/0125898, published Jun. 16, 2022, the content of which is incorporated by reference in its entirety for all purposes.

This application is related to U.S. National Stage application Ser. No. 18/039,364, (Docket No. ORC-007-US), titled “Multi-Platen Ultrasound Fingerprint Sensors And Associated Methods”, filed May 30, 2023, Publication Number WO ______, published, ______, 20______, the content of which is incorporated by reference in its entirety for all purposes.

### FIELD OF THE INVENTIVE CONCEPTS

The present inventive concepts relate generally to systems, devices, and methods that provide a routine to authenticate one or more users, such as by using a witness.

### BACKGROUND

Two-factor authentication improves trust for online accounts by verifying the identity of someone logging into that account through a second device associated with the account or authentic user. For example, when a user logs into a website (e.g., an online store to make a purchase), the website may send a new randomly generated code to a computing device (e.g., a smartphone) previously associated with the registered user of the account, asking that the user input that code to the website. For the code to be entered correctly at the website, the user must also have access to the associated computing device to receive the code. Thus, a correctly entered code provides the website with additional trust that the user is authentic.

Biometric authentication, where a computer device (e.g., a smartphone) compares sensed biometric characteristics of a user attempting to access the computer device, proves a strong level of security for the computer device. Often, such authentication is used within an application running on the computer device when used to access other resources. However, trust that the user is who they claim to be is limited to the trust that the single computer device has not been compromised.

### SUMMARY

According to an aspect of the present inventive concepts, a system for authenticating a user comprises a software product comprising instructions stored on computer-readable media, and the instructions, when executed by a computer, perform steps for witnessing authentication of a user of a user device by a witness using a secondary device. The software product comprises: a first computer-readable media in the user device, comprising at least one of: instructions for receiving a task code from an authentication server; instructions for generating, for display by the user device and based upon the task code, a first part of a virtual screen defining an interactive task implemented by both the user device and the secondary device; instructions for synchronizing the interactive task with a secondary device; instructions for invoking biometric authentication of the user by the user device to generate an authentication result; instructions for capturing first movement data detected by the user device as the user performs the interactive task; and/or instructions for sending the authentication result and the first movement data to the authentication server; and a second computer-readable media in a secondary device, comprising at least one of: instructions for receiving the task code from one of the authentication server or the user device; instructions for generating, for display by the secondary device and based upon the task code, at least part of the virtual screen of the interactive task implemented by both the user device and the secondary device; instructions for synchronizing the interactive task with the user device; instructions for capturing second movement data detected by the secondary device as the user performs the interactive task; and/or instructions for sending the second movement data to the authentication server. The system is configured to authenticate the user to perform an action of high importance.

In some embodiments, the system further comprises a third computer-readable media in an authentication server, comprising at least one of: instructions for generating the task code defining the interactive task and expected movement; instructions for sending the task code to the user device; instructions for receiving the authentication result and the first movement data from the user device; instructions for receiving the second movement data from the secondary device; instructions for analyzing the first movement data, the second movement data, and the expected movement to determine whether the first movement data, the second movement data, and the expected movement match; and/or instructions for determining success of the witnessing authentication when the authentication result indicate successful biometric authentication of the user to the user device and the first movement data, the second movement data, and the expected movement match.

In some embodiments, the action of high importance comprises an action is selected from the group consisting of: performing a financial transaction, such as a financial transaction at a level of one thousand dollars or above; gaining access to information, such as information confidential to a third party; changing a password and/or a unique identification; transferring of power and/or authority, such as power of attorney; making a medical decision, such as a medical decision for an individual; making a military action decision; making a police action decision; making a crisis intervention decision; making a governmental decision; and combinations thereof. The action of high importance can comprise two, three, or more actions of high importance.

In some embodiments, the system further comprises an algorithm configured to authenticate the user. The algorithm can comprise a bias configured to cause the authentication to tend away from a false authentication.

In some embodiments, the system is configured to randomly generate a task code defining an interactive task.

In some embodiments, the first movement data and the second movement data each comprise head, facial, hand, and/or other movement data captured by respective ones of the user device and the secondary device without including identifying biometric information.

In some embodiments, the system comprises a user device including a first screen and a secondary device including a second screen, and the system further comprises a virtual screen comprising the first screen and the second screen, and the system is configured to authenticate the user by the user successfully completing an interactive task on the virtual screen. The interactive task can comprise one, two, or more of: a maze puzzle task; a sequence of facial, hand, and/or other body part movement tasks provided visually and/or audibly; and/or a series of tasks comprising consecutive, non-repeating single digit numbers. The interactive task can comprise one or more tasks that include control of a cursor, icon, and/or other graphic on the virtual screen via head, facial, eye, hand, and/or other body part movement of the user.

In some embodiments, the system is configured to transfer a code from the authentication server to the user, and the code can be transferred in two or more segments. At least one of the two or more segments of the code can be transferred to a witness, and the witness can transfer the received code segment to the user.

In some embodiments, the interactive task can comprise a maze that can be presented to the user in a virtual world.

In some embodiments, the witness comprises an anonymous witness. The anonymous witness can be known to the user, and the system can be configured to register the anonymous witness to the user.

### INCORPORATION BY REFERENCE

All publications, patents, and patent applications mentioned in this specification are herein incorporated by reference to the same extent as if each individual publication, patent, or patent application was specifically and individually indicated to be incorporated by reference. The content of all publications, patents, and patent applications mentioned in this specification are herein incorporated by reference in their entirety for all purposes.

### BRIEF DESCRIPTION OF THE DRAWINGS

FIG. 1 illustrates a schematic view of a system for authenticating one or more users of the system, consistent with the present inventive concepts.

FIG. 1A illustrates a flow chart of a process for performing an action requiring authentication, consistent with the present inventive concepts.

FIG. 2 illustrates one example of an authentication witness system that provides improved level of trust when authenticating a user to an authentication server, consistent with the present inventive concepts.

FIG. 3A illustrates a schematic block diagram showing the system of FIG. 2 in further example detail, consistent with the present inventive concepts.

FIG. 3B illustrates an example head movement captured by both witness and root client devices as the user performs the interactive task of FIG. 3A, consistent with the present inventive concepts.

FIG. 4 illustrates a block diagram showing the application of FIG. 3A in further example detail, consistent with the present inventive concepts.

FIGS. 5, 6 and 7 illustrate three different example types of the interactive task of FIG. 3A, consistent with the present inventive concepts.

FIG. 8 illustrates a high-level block diagram showing the authentication server of FIGS. 2 and 3A in further example detail, consistent with the present inventive concepts.

FIG. 9 illustrates a flowchart showing one example method for witnessed authentication of a user by the client devices of FIG. 2, consistent with the present inventive concepts.

FIG. 10 illustrates a flowchart showing one example method for witnessed authentication of a user by the authentication server of FIG. 2, consistent with the present inventive concepts.

FIG. 11 illustrates a functional block diagram showing one example authentication witness system that provides improved level of trust using a remote witness to authenticate a user to an authentication server, consistent with the present inventive concepts.

FIG. 12 illustrates a flowchart showing one example method for remotely witnessing authentication of a user of a root client device, consistent with the present inventive concepts.

FIG. 13 illustrates a flowchart showing one example remote authentication witness method for witnessing authentication of a user to provide an improved level of trust, consistent with the present inventive concepts.

FIG. 14 illustrates a functional block diagram showing one example system for anonymous remote witnessed authentication, consistent with the present inventive concepts.

### DETAILED DESCRIPTION OF THE DRAWINGS

The terminology used herein is for the purpose of describing particular embodiments and is not intended to be limiting of the inventive concepts. Furthermore, embodiments of the present inventive concepts may include several novel features, no single one of which is solely responsible for its desirable attributes or which is essential to practicing an inventive concept described herein. As used herein, the singular forms “a,” “an” and “the” are intended to include the plural forms as well, unless the context clearly indicates otherwise.

It will be further understood that the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers, and/or sections, these limitations, elements, components, regions, layers, and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on”, “attached”, “connected” or “coupled” to another element, it can be directly on or above, or connected or coupled to, the other element, or one or more intervening elements can be present. In contrast, when an element is referred to as being “directly on”, “directly attached”, “directly connected” or “directly coupled” to another element, there are no intervening elements present. Other words used to describe the relationship between elements should be interpreted in a like fashion (e.g., e.g., “between” versus “directly between,” “adjacent” versus “directly adjacent,” etc.). A first component (e.g., e.g., a device, assembly, housing or other component) can be “attached”, “connected” or “coupled” to another component via a connecting filament (as defined below). In some embodiments, an assembly comprising multiple components connected by one or more connecting filaments is created during a manufacturing process (e.g., pre-connected at the time of an implantation procedure of the apparatus of the present inventive concepts). Alternatively or additionally, a connecting filament can comprise one or more connectors (e.g., a connectorized filament comprising a connector on one or both ends), and a similar assembly can be created by a user operably attaching the one or more connectors of the connecting filament to one or more mating connectors of one or more components of the assembly.

It will be further understood that when a first element is referred to as being “in”, “on” and/or “within” a second element, the first element can be positioned: within an internal space of the second element, within a portion of the second element (e.g., within a wall of the second element); positioned on an external and/or internal surface of the second element; and combinations of one or more of these.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in a figure is turned over, elements described as “below” and/or “beneath” other elements or features would then be oriented “above” the other elements or features. The device can be otherwise oriented (e.g., rotated 90 degrees or at other orientations) and the spatially relative descriptors used herein interpreted accordingly.

As used herein, the term “proximate” shall include locations relatively close to, on, in, and/or within a referenced component or other location.

The term “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

The term “functional element” where used herein, is the be taken to include a component comprising one, two or more of: a sensor; a transducer; an electrode; an energy delivery element; an agent delivery element; a magnetic field generating transducer; and combinations of one or more of these. In some embodiments, a functional element comprises a transducer selected from the group consisting of: light delivery element; light emitting diode; wireless transmitter; Bluetooth device; mechanical transducer; piezoelectric transducer; pressure transducer; temperature transducer; humidity transducer; vibrational transducer; audio transducer; speaker; and combinations of one or more of these. In some embodiments, a functional element comprises a needle, a catheter (e.g., a distal portion of a catheter), an iontophoretic element or a porous membrane, such as an agent delivery element configured to deliver one or more agents. In some embodiments, a functional element comprises one or more sensors selected from the group consisting of: electrode; sensor configured to record electrical activity of tissue; blood glucose sensor such as an optical blood glucose sensor; pressure sensor; blood pressure sensor; heart rate sensor; inflammation sensor; neural activity sensor; muscular activity sensor; pH sensor; strain gauge; accelerometer; gyroscope; GPS; respiration sensor; respiration rate sensor; temperature sensor; magnetic sensor; optical sensor; MEMs sensor; chemical sensor; hormone sensor; impedance sensor; tissue impedance sensor; body position sensor; body motion sensor; physical activity level sensor; perspiration sensor; hydration sensor; breath monitoring sensor; sleep monitoring sensor; food intake monitoring sensor; urine movement sensor; bowel movement sensor; tremor sensor; pain level sensor; orientation sensor; motion sensor; and combinations of one or more of these.

The term “transducer” where used herein is to be taken to include any component or combination of components that receives energy or any input, and produces an output. For example, a transducer can include an electrode that receives electrical energy, and distributes the electrical energy to tissue (e.g., based on the size of the electrode). In some configurations, a transducer converts an electrical signal into any output, such as light (e.g., a transducer comprising a light emitting diode or light bulb), sound (e.g., a transducer comprising a piezo crystal configured to deliver ultrasound energy), pressure, heat energy, cryogenic energy, chemical energy, mechanical energy (e.g., a transducer comprising a motor or a solenoid), magnetic energy, and/or a different electrical signal (e.g., a Bluetooth or other wireless communication element). Alternatively or additionally, a transducer can convert a physical quantity (e.g., variations in a physical quantity) into an electrical signal. A transducer can include any component that delivers energy and/or an agent to tissue, such as a transducer configured to deliver one or more of: electrical energy to tissue (e.g., a transducer comprising one or more electrodes); light energy to tissue (e.g., a transducer comprising a laser, light emitting diode and/or optical component such as a lens or prism); mechanical energy to tissue (e.g., a transducer comprising a tissue manipulating element); sound energy to tissue (e.g., a transducer comprising a piezo crystal); thermal energy to tissue (e.g., heat energy and/or cryogenic energy); chemical energy; electromagnetic energy; magnetic energy; and combinations of one or more of these.

The term “transmission signal” where used herein is to be taken to include any signal transmitted between two components, such as via a wired or wireless communication pathway. A transmission signal can include one or more signals transmitted using skin conduction. Alternatively or additionally, a transmission signal can comprise reflected energy, such as energy reflected from any power and/or data signal.

The term “data signal” where used herein is to be taken to include a transmission signal including at least data. A data signal can comprise a radiofrequency signal including data (e.g., a radiofrequency signal including both power and data) and/or a data signal sent using skin conduction.

The terms “attachment”, “attached”, “attaching”, “connection”, “connected”, “connecting” and the like, where used herein, are to be taken to include any type of connection between two or more components. The connection can include an “operable connection” or “operable attachment” which allows multiple connected components to operate together such as to transfer information, power, and/or material (e.g., an agent to be delivered) between the components. An operable connection can include a physical connection, such as a physical connection including a connection between two or more: wires or other conductors (e.g., an “electrical connection”), optical fibers, wave guides, tubes such as fluid transport tubes, and/or linkages such as translatable rods or other mechanical linkages. Alternatively or additionally, an operable connection can include a non-physical or “wireless” connection, such as a wireless connection in which information and/or power is transmitted between components using electromagnetic energy. A connection can include a connection selected from the group consisting of: a wired connection; a wireless connection; an electrical connection; a mechanical connection; an optical connection; a sound propagating connection; a fluid connection; and combinations of one or more of these.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. For example, it will be appreciated that all features set out in any of the claims (whether independent or dependent) can be combined in any given way.

One aspect of the present embodiments includes the realization that increasing use of biometrics on a single authenticating device (e.g., a smartphone with a fingerprint reader, and/or facial recognition), to identify and authenticate a user (e.g., an individual person), results in a misplaced high “level of trust” in believing that the single authenticating device has not been compromised. This misplaced and/or limited level of trust in the single authenticating device can occur when the user attempts to access a high value or highly sensitive resource, such as making a high value monetary transaction. An unacceptable level of trust (e.g. a level of trust below a threshold, such as a threshold that is dependent on the particular action to be performed) can occur when any important action is to be initiated, modified, or stopped (“modifying” the action herein) via a single device. For example, an action of high importance of the present inventive concepts can comprise an action (e.g., a decision) that may affect an individual's health (e.g., a life and death decision, and/or other important medical decision for an individual that is not the individual making the decision), or any action that may include an important decision (e.g., a military decision, a police action decision, a fire or other crisis intervention decision, a governmental decision, and the like) can be authorized and/or otherwise confirmed as acceptable using the systems and methods described herein. An entity controlling the access, making the transaction, and/or modifying the action often requires a higher level of assurance (e.g., evidence) that the user is who they claim to be than can be provided by the limited trust in the single authenticating device. However, since unique biometric data (e.g., a fingerprint or 3D facial ID) often cannot, for security and/or policy-driven reasons, be sent to a website or uploaded to the cloud for authentication, trust in biometric authentication relies on the single authenticating device not being compromised.

The present embodiments solve this problem by using two devices concurrently, since it is significantly more difficult to compromise two independent devices than it is to compromise a single device. A second client device (a witness client device) is used to witness an authentication (e.g., a biometric authentication and/or another authentication method) of the user on the first authenticating device (a root client device). That is, the witness client device witnesses the authentication of the user on the root client device and provides evidence thereof. The root client device can belong to the individual being authenticated (the “user”) and the witness client device may be one of (a) another device belonging to the user, (b) a device belonging to a party preauthorized for witnessing the authentication of the user, or (c) a previously unknown device. As the root client device performs an authentication (e.g., at least a biometric authentication) of the user, the witness client device captures and provides evidence, without including sensitive confidential data (e.g., biometric images and/or other sensitive data), to an authentication server. In some embodiments, the witness client device was present during the authentication performed on the root client device. The root client device and the witness client device can be positioned adjacent to one another as the user authenticates, and both the root and witness client devices can capture various evidence of the identification of the user, such as non-identifying evidence that includes movement data, action data, physiologic data, and/or other user data used to identify a user and/or identify a person as an imposter (singly or collectively “recognition data”, “user recognition data”, “biometric data”, “biometric information”, “biometric characteristics”, “biometric signature”, and/or “biometrics” herein). In some embodiments, user recognition data comprises data related to movement selected from the group consisting of: one or more of: head movement eye and/or eyelid movement; mouth movement; lip movement; tongue movement; facial expressions; facial muscle movement, arm movement; wrist movement; hand movement; finger movement; other body part movement; and combinations of these. In some embodiments, user recognition data comprises physiologic data of the user selected from the group consisting of: PPG data; blood flow data; blood pressure data; respiration data; DNA data; EKG data; perspiration data; other physiologic data; and combinations of these. In some embodiments, recognition data, such as that described herein, can comprise data collected from a witness and used to authenticate a witness. The root and witness client devices can independently send the captured recognition data to an authentication server where it is processed, such as to determine that both client devices were present during an authentication of the user. Further, the user, and sometimes the witness, may be asked to perform a task (e.g., a randomly selected and/or randomly generated interactive task) during the authentication such that the recognition data includes data related to movements corresponding to the task that may be evaluated by the authentication server to determine that the particular task was performed at the time of authentication, and that the evidence provided regarding performance of the task was not previously recorded. For example, if the task is randomly selected and/or randomly generated, the required movement is not predictable; thus, previously recorded evidence would not match expected movements and is therefore detected as fraudulent by the authentication server.

A level of trust in the authentication of the user is increased by a level of trust in the witness client device since the witness client device also authenticates the witness prior to and/or after witnessing authentication of the user by the root client device. In one analogy, the witness client device acts with the root client device like a notary public serving as an impartial witness when another person signs important documents. This higher level of trust is afforded, at least in part, by the increased probability that a “nefarious party” is unlikely to have compromised both the root client device and the witness client device, and in part by the fact that the application running on both the root client device and the witness client device includes a combination of measures that make spoofing and scamming the authentication and witnessing difficult if not impossible. As a further measure of authenticity, the roles of the user and the witness may be reversed such that the witness is also authenticated and witnessed. Advantageously, the described systems and methods provide a particular added value of confirming that the user and witness using biometrics on their own client devices, while simultaneously capturing and sharing movements related to the biometric authentications with a website requiring a confirmation of the authentication, and without sharing any unique identifying biometric information with the website. This witnessed authentication improves trust for the website that the user being authenticated by the root client device is who they claim to be.

A person (e.g., an individual to be authenticated, the “user” herein) may have a group of people (e.g., friends) that they trust to confirm their identity to a third party. Such people are likely better at identifying the user than some remote and often unknown person at a third-party entity (e.g., a bank, cable service, and/or cellular access company) who asks them to verify predefined answers to one or more preset questions (e.g., a name of their first pet, a name of their teacher in 8th grade, and the like). The embodiments described herein provide a service that allows the user to call on any one or more of these trusted people to witness authentication for a third party, such as a website, a bank, and the like. Such witnessing may occur in person when the user and the witness are at the same location, or remotely when the witness is not at the same location as the user. The use of a shared virtual screen that appears in part on the root client device and in part on the witness client device, enables the website to verify that the root client device and the witness client device are near one another as the user interacts with the virtual screen on both client devices.

In some embodiments, a witnessed authentication method includes: determining, at an authentication server, that a higher level of trust in authentication of a user is required and/or desired (“required” herein) for the user to access a protected resource; receiving, at the authentication server from a first application running on a root client device associated with the user, a current location of the root client device; selecting, based upon the current location, a witness client device that (a) has previously been configured to provide witness services to the authentication server, and (b) is near the current location; directing, via a second application running on the witness client device, an owner of the witness client device to (a) authenticate on the witness client device and then (b) to hand the witness client device to the user; synchronizing the root and witness client devices using the first and second applications; authenticating the user on the root client device using a “user recognition routine” (e.g., a facial recognition routine and/or other routine performed by an algorithm of the system to positively identify a particular user) to determine an authentication result; corroboratively implementing, between the root and witness client devices, an interactive task randomly selected by the authentication server to cause the user to make predefined facial movements; capturing, by the first application on the root client device, first recognition data (e.g., first movement data of facial movements) detected by the root client device as the user performs the interactive task; capturing, concurrently by the second application on the witness client device, second recognition data (e.g., second movement data of facial movements) detected by the witness client device as the user performs the interactive task; receiving, at the authentication server from the root client device, an authentication result indicative of success of the authentication of the user and the first recognition data; receiving, at the authentication server from the witness client device, the second recognition data; and determining, based upon the authentication result, the first recognition data, the second recognition data, and expected recognition data, whether the user is authorized to access the protected resource.

In some embodiments, a witnessed authentication method using a root client device and a witness client device, includes: receiving, by an application running on a first client device, a message including a task code from an authentication server; synchronizing the first client device with a second client device; generating, for display by the first client device and based at least in part upon the task code, at least part of a virtual screen of an interactive task implemented by (e.g., split between) both the first and second client devices; when the first client device is the root client device: invoking authentication of a user on the first client device; capturing first recognition data (e.g., first movement data and/or first action data) detected by the first client device as the user performs the interactive task; and sending authentication results and the first recognition data to the authentication server; when the second client device is the witness client device: capturing second recognition data (e.g., second movement data) detected by the second client device as the user performs the interactive task; and sending the second recognition data to the authentication server. The authentication server determines whether the witnessed authentication of the user is successful based upon the authentication result, the first recognition data, and the second recognition data.

In some embodiments, a witnessed authentication method includes: determining, at an authentication server, a higher level of trust is required for a user of an account; selecting a root client device based upon the account; selecting a witness client device; generating a task code defining an interactive task and expected user response (e.g., user movement and/or other user action, such as an action of the user that is used by the system to identify the user and/or perform another function) of the user such that the interactive task is not predictable; sending a message with the task code to the root client device; sending a message with the task code to the witness client device; receiving authentication results and first recognition data (e.g., first movement data and/or action data) from the root client device, the authentication result defining whether the user authenticated successfully on the root client device and the first recognition data defining a first user response (e.g., a user movement and/or user action) of the user as detected by the root client device during witnessed authentication of the user; receiving second recognition data (e.g., second movement data and/or action data) from the witness client device, the second recognition data defining a second user response (e.g., a user movement and/or user action) of the user as detected by the witness client device; and evaluating the authentication results and comparing the first recognition data, the second recognition data, and expected physiologic response (e.g., expected movement) to determine success or failure of the witnessed authentication.

In some embodiments, a software product includes instructions, stored on computer-readable media, wherein the instructions, when executed by a computer, perform steps for witnessing authentication of a first user of a root client device, the software product including: a first computer-readable media in a root client device, comprising: instructions for receiving a first message including a task code from an authentication server; instructions for synchronizing with a witness client device; instructions for generating, for display by the root client device and based upon the task code, at least part of a virtual screen of an interactive task implemented by both the root client device and the witness client device; instructions for invoking authentication of the user to generate an authentication result; instructions for capturing first recognition data (e.g., first movement data) detected by the root client device as the user performs the interactive task; and instructions for sending the authentication result and the first recognition data to an authentication server; and a second computer-readable media in a witness client device, comprising: instructions for receiving a second message including the task code from the authentication server; instructions for synchronizing with the root client device; instructions for generating, for display by the witness client device and based upon the task code, at least part of the virtual screen of the interactive task implemented by both the root client device and the witness client device; instructions for capturing second recognition data (e.g., second movement data) detected by the witness client device as the user performs the interactive task; and instructions for sending the second recognition data to the authentication server.

Information sent over the Internet may be captured and used by a nefarious party (e.g., one or more nefarious persons). In a simple example, a nefarious party captures and replays login credentials used by an authorized person to access a website and imitate the authorized person. A biometric image may be similarly captured and replayed to gain unauthorized access to a website. Accordingly, biometric authentication requires that biometric data (e.g., facial images, fingerprint images, and other forms of biometric data such as those described herein) of the person being authenticated is not sent over the Internet. For example, on a “client device” (e.g., a smartphone, tablet computer, laptop computer, and the like) authentication is handled by a secure enclave of the client device such that biometric images and/or other sensitive information are not transferred or uploaded to a cloud service for evaluation and are not stored on the client device. This practice has become an industry norm that may be regulated in certain regions. Two-factor authentication is an improvement over conventional username and password login authentication, since it requires that the person accessing the protected resource (e.g., website) also has access to a trusted device (e.g., a smartphone or other client device previously associated with the protected resource). Two-factor authentication thus blocks access through mere copying and replaying of credentials without simultaneous access to the trusted device. However, two-factor authentication may still provide insufficient proof of a person's authenticity, such as when the resource being protected has high value and/or a high level of importance (e.g., large value transactions, transfer of power and/or authority (e.g., power of attorney), modification of an action that is of high importance, and the like). Although unlikely, one vulnerability of two-factor authentication is that the SIM card of the trusted device is stolen and used in an “impersonating device”. When a code is sent to the trusted device using the corresponding phone number, the code is received on the impersonating device, thereby allowing an imposter to provide the code to a website and gain access.

### Levels of Trust

A first “level of trust”, that the user is who they say they are, can be based on biometric information of the user being authenticated by a client device. The client device can be for example a smartphone, and includes at least one biometric sensor (e.g., a camera for facial recognition, a fingerprint sensor for fingerprint recognition, a sensor for recording or otherwise measuring motion of a body part of the user, a sensor for measuring a physiologic parameter of the user, and the like) that authenticates presented biometric information (e.g., presented by the user) to the client device. The client device can authenticate the presented biometric information of the user without storing biometric information on the client device and/or without sending the biometric information to a separate device (e.g., a server of a third party). However, this authentication requires trust that the client device is not compromised; thus, the trust is based on integrity of the single client device. In the well-known two-factor authentication, trust of the client device is confirmed by sending an unpredictable (e.g., random) code value to the client device via a trusted path (e.g., a text message sent to a known phone number of the device) and asking the user of a website to input that code, thereby requiring that the user accessing the website also has access to the client device. Since the client device requires authentication of the user to access the code, when the code is entered correctly to the website, the user has proved trust in the client device to the website.

The systems of the present inventive concepts can be configured to perform various passwordless authentication methods, such as those described in co-pending U.S. patent application Ser. No. 17/290,740, titled “Passwordless Authentication Systems and Methods”, filed Apr. 30, 2021.

### Overcoming Limited Trust in a Single Client Device

Using a single client device to authenticate a user to a third party relies upon the level of trust that the third party has in that client device. This level of trust is based on the owner of the device immediately reporting a loss, and of trusting that the owner of the device is using the biometric authentication built into that device to prevent misuse. However, even with built in biometric authentication, a determined hacker may gain access to that device, or to its SIM card. Thus, the trust in a single client device has limitations and reliance that the client device is not compromised. For situations where trust in a single client device is insufficient, such as where an asset being accessed (e.g., a high-value transaction, a high-cost action, an action of high importance, and the like) requires a higher level of trust than afforded by the single client device, a third party responsible for that asset may not permit access (or permit an associated transaction or other event requiring authentication) until a higher level of trust is provided. For example, the third party may require additional proof of identity, even physical appearance, before allowing access or performing the requested transaction or other event.

The embodiments herein provide increased trust over the use of a single client device, by additionally using a second client device, a “witness client device” (also referred to as “witness device” herein), to further witness the authentication of the user on a first client device, a “root client device” (also referred to as “root device” herein). More particularly, the root and witness client devices independently provide evidence that the two client devices were at the same location during witnessing of the authentication. Since a nefarious party would need to compromise each of the two client devices, the use of both client devices to authenticate and witness the authentication provides an increased level of trust (a third level of trust), particularly when the witness client device is also known to the third party. This additional trust can be achieved by using a second trusted client device (a witness client device belonging to a second trusted party) to verify (e.g., witness) the authentication of the user on the root client device. Evidence of witnessing the authentication of the user to the root client device is sent to the third party (e.g., the entity operating the website and/or otherwise requiring authentication of the event) where it can be used to further increase trust in the authentication by eliminating or at least reducing (“eliminating”, “preventing” or “reducing” herein) spoofing and scamming possibilities.

The following embodiments are described using facial authentication to gather “user recognition data” (also referred to as “recognition data” herein), but it should be considered within the spirit and scope of the present inventive concepts that other types of user identification can be used. For example, other types of biometric authentication can be used to gather user recognition data, such as iris recognition, retinal scanning, physiologic parameter analysis, and the like. User recognition data can comprise movement data gathered from the user, such as movement of the user's head, eyes, mouth, lips, tongue, facial muscles, and/or other body part movement. Movement data of the present inventive concepts (e.g., movement data 651 and/or 652 described hereinbelow) can comprise one or more forms of movement data as described herein, as well as other user recognition data, such as data related to a task or other action of the user, and/or physiologic information of the user.

Recognition data of the present inventive concepts can comprise data related to an image, such as image data created by a device selected from the group consisting of: a visible light camera and/or an infrared camera; a laser or other optical imaging device; an X-ray imager; a CT-scan imager; an ultrasound imager; a PET scan imager; another imaging device; and combinations of these. The image data can comprise fingerprints, palm prints, and/or toe prints. The image data can comprise images of the patient's eye (e.g., a retinal scan image), face, teeth, bones, blood vessels, and/or other body parts.

Alternatively or additionally, recognition data of the present inventive concepts can comprise data associated with motion of the user, such as motion of the user's head, face, eye, mouth, lips, tongue, arm, wrist, finger, and/or other body part.

Alternatively or additionally, recognition data of the present inventive concepts can comprise data related to a physiologic parameter of the patient, such as a physiologic parameter selected from the group consisting of: blood oxygen level (e.g., as determined using a pulse oximeter); blood volume; a parameter determined from a photoplethysmogram (PPG); blood pressure; heart rate; heart electrical activity (e.g., EKG data); respiration; brain waves (e.g., EEG, LFP, and/or neural spike data); blood glucose; a blood gas level; another physiologic parameter; and combinations of these.

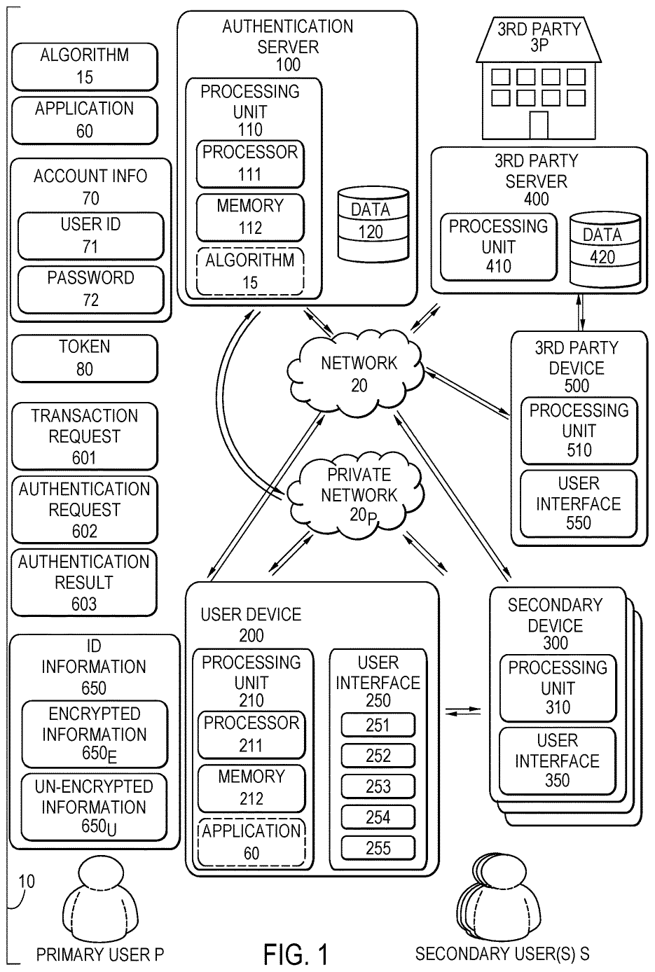

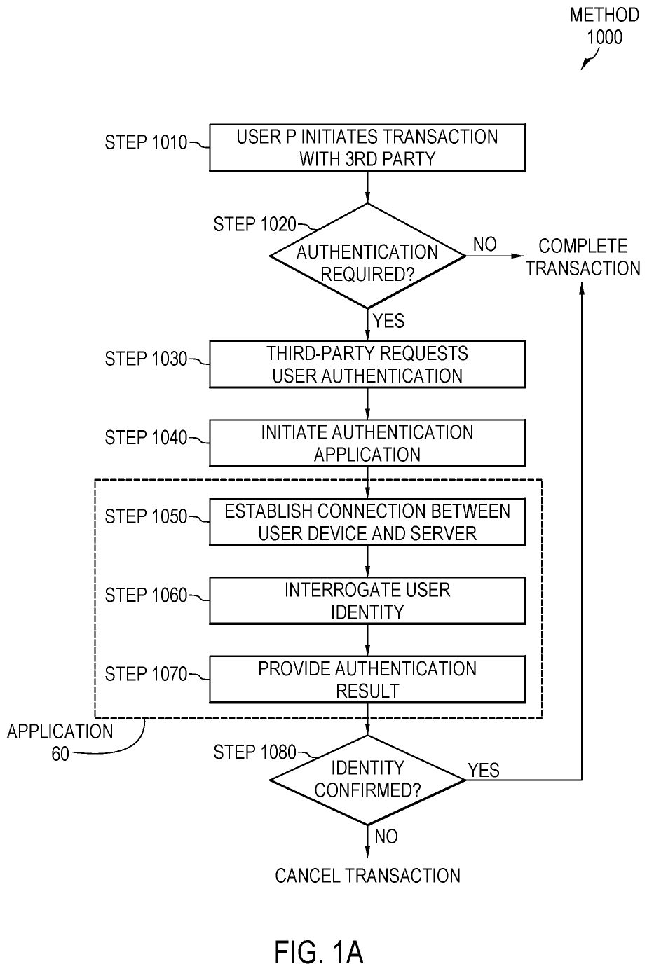

Referring now to FIG. 1, a schematic view of a system for authenticating one or more users of the system is illustrated, consistent with the present inventive concepts. System 10 can be used by one or more users, such as by a primary user, user P, and one or more secondary users, user S. System 10 can be used to authenticate the identity of one of more users of the system (“authenticate” a user herein), for example to authenticate the identity of user P for an online or in-person transaction, such as a wire transfer, and/or any action of high importance as described herein. System 10 can authenticate a user via one or more identity verification processes described herein. In some embodiments, the “level of trust” of the user authentication can be increased by additional verification steps, the use of additional devices, and/or by incorporating feedback from additional users of system 10 to authenticate user. System 10 can include authentication server 100 configured to receive and analyze data (e.g., data provided by user P) to authenticate the user's identity. System 10 can include one or more devices for use by user P, user device 200, and/or can include one or more devices for use by user S, secondary device 300. User device 200 and/or secondary device 300 can collect data, as described herein, to be provided to authentication server 100 to authenticate a user P. User device 200 and secondary device 300 can be referred to singly or collectively herein as client devices 200 and/or 300.

In some embodiments, system 10 provides proof of authentication to an entity, institution, or other third party, third-party 3P. In some embodiments, third-party 3P comprises a financial institution, a law firm, or other person or institution requiring the authentication of a user. In some embodiments, third-party 3P maintains a computing system, third-party server 400, through which third-party 3P processes one or more transactions (e.g., actions) between a user or client of third-party 3P, for example a user P, such as transactions that require user authentication. In some embodiments, system 10 includes a device that is maintained by third-party 3P, third-party device 500, for example a terminal at a bank that is operated by an agent of third-party 3P (e.g., a bank teller) and/or by user P. As used herein, unless otherwise distinguished, a “user” of system 10 can include user P, secondary user S, an agent of third-party 3P, and/or another individual or group of individuals that use system 10 and/or are used by system 10.

The various servers and devices of system 10 (e.g., servers 100 and 400, and devices 200, 300, and 500) communicate via one or more networks, such as one or more wired or wireless networks. For example, system 10 can comprise network 20, such as the Internet, cellular networks, and/or other wide area public networks. Additionally or alternatively, system 10 can comprise network 20_{P} comprising a private network, such as a network that is only accessible to the servers and devices of system 10. In some embodiments, network 20_{P} comprises a virtual private network (VPN) that operates at least in part via network 20. As used herein, network 20 can be inclusive of network 20_{P}. In some embodiments, two or more devices of system 10 can communicate directly (e.g., without a network) via a Bluetooth, Zigbee, a near-field communication (NFC) protocol, or other short range wireless protocol.

System 10 can comprise one or more processing units, each comprising one or more processors. Each processor can be configured to execute one or more algorithms, the instructions for which are stored in memory operably coupled to the processor. For example, authentication server 100 can comprise processing unit 110, that includes processor 111, operably coupled to memory 112. Memory 112 can store instructions for one or more executable routines, such as a routine performed by an algorithm, algorithm 15. Similarly, user device 200 can comprise processing unit 210, that includes processor 211, operably coupled to memory 212. Memory 112 can store instructions for one or more executable routines, such as one or more executable routines of algorithm 15. Secondary device 300, third-party sever 400, and/or third-party device 500 can similarly each include processing units 310, 410, and/or 510, respectively, for storing instructions for performing and/or otherwise executing one or more routines of algorithm 15 of system 10, as described herein.

User device 200 can comprise an interface, user interface 250, for providing and/or receiving information to and/or from user P. User interface 250 can include one or more user input and/or output components. For example, user interface 250 can comprise a keyboard, mouse, touchscreen, and/or another human interface device, user input component 251 shown. In some embodiments, user interface 250 can comprise a speaker, indicator light, haptic transducer, and/or another human interface device, user output component 252 shown. User interface 250 can include one or more visual outputs, display 253. User device 200 can be configured to provide an interactive graphical user interface, GUI 254, such as a graphical user interface provided by algorithm 15. In some embodiments, GUI 254 is displayed to user P on display 253. In some embodiments, user interface 250 comprises a sensor configured to capture information that can be correlated to the identity of user P, ID sensor 255. For example, ID sensor 255 can include a camera, such as a visual light camera and/or an infrared camera, a fingerprint sensor, a biological parameter sensor, such as a blood gas sensor or a photoplethysmography (PPG) sensor, a microphone, a transducer, such as a LED or an audio transducer, and/or other sensors described herein. In some embodiments, ID sensor 255 comprises a LiDAR-based component, such as a LiDAR sensor configured to capture 3D data of an individual's face or other body part. Secondary device 300 and/or third-party device 500 can similarly each include user interfaces 350 and 550, respectively, for providing and/or receiving information from a user, such as user P, secondary user S, and/or an agent of third-party 3P.

System 10 can be configured to collect (e.g., via devices 200 and/or 300) and store data related to one or more users of system 10, data 120 (also referred to herein as database 120). Data 120 can include data collected before a user authentication is performed by system 10, such as data collected from user P to be used to authenticate the user at a later date, such as facial recognition data, fingerprint data, behavioral data, and/or other information that can be used by system 10 to authenticate user P. Additionally or alternatively, data 120 can include data collected during a user authentication, such as data that is compared to previously recorded information to authenticate the identity of user P. In some embodiments, user identification data (e.g., user P's fingerprints) are not provided to third-party 3P, such as to protect the identity of user P. For example, authentication server 100 can authenticate user P, and provide proof of authentication to third-party 3P without revealing the identifying information, as described herein.

In some embodiments, third-party 3P collects and stores data, data 420 shown, comprising data related to one or more users of system 10 (e.g., user P and/or secondary user S). For example, one or more users of system 10 may have a user account with third-party 3P (e.g., an account to access a service provided by third-party server 400), the account including information related to the user, account info 70. In some embodiments, account info 70 includes a unique user identifier, user ID 71, and/or account info 70 can include a security key, password 72. In some embodiments, as described herein, a user of system 10 can provide an associated user ID 71 and password 72 in order to establish a secure connection (e.g., to “log in”) to third-party server 400. Additionally or alternatively, one or more users of system 10 may have an account with authentication server 100, the account including account info 70 (e.g., information stored as data 120), including user ID 71 and/or password 72 used to log in to authentication server 100 (e.g., prior to or while performing application 60). In some embodiments, logging into a server of system 10 (e.g., a “host server” such as authentication server 100 or third-party server 400) requires multi-factor authentication (MFA). MFA can be based on one, two or more “factors”, such as password 72 and at least one additional identifying piece of information used to authenticate the user (e.g., ID information 650 described herein). In some embodiments, one or more devices of system 10 (e.g., server 100 and/or 400) can generate a unique identifier, token 80, such as a randomly generated code used in a MFA process. For example, a MFA process can require providing a password as well as proof of possession of a physical device, for example user device 200. The host server can be configured to generate token 80, and to transmit token 80 to device 200 (e.g., via text message). User P can subsequently provide token 80 to the host server in order to prove user P is in possession of device 200.

In some embodiments, system 10 comprises instructions for operating an application, application 60. Instructions for application 60 can be stored in memory of system 10, for example in memory 212 of user device 200. Application 60 can be configured to initiate one or more of algorithms 15 to perform an authentication procedure to authenticate user P, an “identity verification process”. Application 60 can be configured to run on one or more devices of system 10, such as user device 200 and/or on secondary device 300. For example, application 60 can be downloaded from authentication server 100 onto user device 200 and can be executed by processing unit 210. Application 60 can initiate communication between one or more servers or devices of system 10, such as to transfer data and/or results of an authentication process. In some embodiments, the identity verification process of application 60 can provide an additional level of trust beyond the use of user ID 71 and password 72 provided by user P to third-party 3P to initiate a transaction (e.g., a financial transaction and/or other action of high importance as described herein).

Referring additionally to FIG. 1A, a flow chart of a process of performing a transaction requiring authentication is illustrated, consistent with the present inventive concepts. Method 1000 can be implemented by system 10 to authenticate user P when third-party 3P requires authentication to complete a transaction (e.g., a wire transfer) and/or other action of high importance (“transaction” and/or “action” herein). In Step 1010, user P requests the initiation of a transaction by sending transaction request 601 from user device 200 to third-party server 400. Transaction request 601 can be sent via network 20. In some embodiments, transaction request 601 is generated by user P via third-party device 500. In Step 1020, third-party server 400 determines if user authentication, such as an initial or subsequent (e.g., second, third, or forth) user authentication, is required to complete the requested transaction (e.g., an action of high importance as described herein). If authentication is not required, third-party server 400 can complete the transaction without continuing method 1000. In some embodiments, in Step 1010 (or prior to Step 1010), user P provides user ID 71 and/or password 72 to third-party server 400 to establish a first level of authentication. In these embodiments, Step 1020 determines if additional authentication (e.g., an additional level of trust) is required to complete the transaction.

If, in Step 1020, authentication is required, in Step 1030, third-party server 400 sends authentication request 602 to authentication server 100 and/or to user device 200. In Step 1040, the receipt of authentication request 602 initiates application 60 comprising an authentication application on user device 200. For example, third-party server 400 can send authentication request 602 to user device 200, which initiates application 60 on user device 200. Alternatively or additionally, third-party server 400 can send authentication request 602 directly to authentication server 100, which can subsequently forward the request to user device 200, initiating application 60. In Step 1050, a connection is established between user device 200 and authentication server 100, for example a secure connection via private network 20_{P}.

In Step 1060, authentication server 100 interrogates the identity of user P, for example using the methods described herein. In some embodiments, information related to the identity of user P, ID information 650, is transferred between user device 200 and authentication server 100. ID information 650 can comprise information that has been encrypted (e.g. by user device 200 and/or authentication server 100), encrypted information 650E, and/or information that has not been encrypted, un-encrypted information 650_{U}. Information 650E and/or 650_{U} can comprise data selected from the group consisting of: user motion data; user face and/or other body part data (e.g. image data); data used to identify a user; data used to perform a task; and combinations of these. In some embodiments, ID information 650 is encrypted and/or decrypted by system 10 using an asymmetric encryption algorithm, such as an RSA encryption algorithm.

In Step 1070, authentication server 100 provides the results of the identity verification process, authentication result 603, to third-party server 400 and/or to user device 200. In Step 1080, third-party server 400 receives authentication result 603. If user P's identity was confirmed by the verification process, third-party server 400 can complete the transaction initially requested via transaction request 601. If the identity was not confirmed, third-party server 400 can cancel the transaction.

In some embodiments, the identity verification process of application 60 incorporates the use of a secondary device 300, and/or a secondary user S. For example, as described herein, secondary user S can provide input to assist in the verification of the identity of user P. Alternatively or additionally, also as described herein, secondary device 300 can record movement of user P (e.g., movement directed by application 60) and send ID information 650 comprising movement data to authentication server 100.

In some embodiments, user device 200 comprises two, three, or more devices, for example when user P owns multiple cell phones. In some embodiments, application 60 executes concurrently on two or more user devices 200, for example when user P performs the identity verification process of application 60 on two or more devices simultaneously to increase the level of trust of the authentication.

In some embodiments, one or more devices of system 10, such as user device 200 or secondary device 300, comprise an encrypted cell phone and/or other encrypted device (“encrypted cell phone” herein). In some embodiments, user device 200 and/or secondary device 300 comprises two or more cell phones of a user P, such as when at least one cell phone of user P comprises an encrypted cell phone. In these embodiments, application 60 can be executed on at least an encrypted cell phone when user P performs the identity verification process of application 60. In some embodiments, application 60 is executed on at least an encrypted cell phone and another device (e.g., another cell phone or other device of user P). In some embodiments, an encrypted cell phone of secondary user, user S, is used in the verification, as described herein.

In some embodiments, data collected by system 10 (e.g., by one or more cell phones and/or other devices as described herein) to perform application 60 comprises handwriting data and/or typing data entered by and/or otherwise captured from a user of system 10. In some embodiments, system 10 performs continuous and/or semi-continuous user authentication based on typing analysis.

In some embodiments, user ID 71 comprises a digital identity certificate, and password 72 comprises an authorization key. In some embodiments, a user of system 10 can be registered with a host server using a location specific access code and/or the user's mobile device.

In some embodiments, account info 70 includes “pre-registered” information related to the user. A MFA process can include interrogation of the user including answering of questions related to the pre-registered information.

In some embodiments, MFA factors (e.g., token 80) are contained within a mutual authentication payload (MAP) protocol.

In some embodiments, MFA is based on factors selected from the group consisting of: device ownership and/or possession (e.g., a cell phone); biometric data; voice analysis data; public keys; private keys; hash values; PIN; device tokens; push confirmations; device certificates; the proximity of two or more devices; location data from one or more devices; proximity information from two or more devices; environmental data; IP addresses; physical location data; geography data; cookies; challenge keys; certificate info; and combinations of these. In some embodiments, authentication is based on similarities between two or more factors, such as between the IP address of the user and the physical (geographic) location of the user.

In some embodiments, MFA is based on dynamic data, a card reader, and/or a scramble code. For example, a host server can be configured to generate PIN data based on user input data, to generate a PIN block including the PIN data and the card information, and to transmit the PIN block for authentication.

In some embodiments, user device 200 includes a card-device (e.g., a “smartcard”) that can be used in a MFA process. A MFA process can include, two, three, four, or more-factor authentication, such as authentication based on one or more factors selected from the group consisting of: “what you (the user) know”; “what you have”; “what you are”; and combinations of these. In some embodiments, a user device 200 comprising a smartcard can include one or more partially and/or fully virtualized components. In some embodiments, the smartcard can include biometric and/or hardware identifiers configured to determine user specific virtual smartcard objects. In some embodiments, user device 200 can comprise a smartcard and a cell phone, and authentication can be based on the proximity of the two devices.

In some embodiments, token 80 comprises a “one time password” (OTP) generated by the host server. Token 80 can be used to authorize a user to log into a host server via a network, such as network 20.

In some embodiments, user device 200 includes a user wearable electronic tag, such as an electronic tag configured to record biometric information from the user (e.g., from user P).

In some embodiments, account info 70 includes information related to one or more of a user's online transactions (e.g., one or more recent online transactions). In some embodiments, a host server queries the user based on recent transaction history in a MFA process.

In some embodiments, ID sensor 255 is configured to record biometric data of user P, for example, one, two, three, or more biometric readings, such as biometric readings selected from the group consisting of: fingerprint scan; iris scan; facial scan; eye tracking scan, such as eye gaze tracking; voice scan; heart rate reading; and combinations of these.

In some embodiments, a MFA process and/or an authentication process of application 60 comprises a limited time window (e.g., the authentication fails if not completed within a time threshold).

In some embodiments, a MFA process is executed by system 10 without additional user interaction, a “frictionless MFA” (e.g., without user interaction beyond providing password 72), such as when user device 200 provides the host server with location information as a second form of authentication.

In some embodiments, user authentication performed by system 10 is based on “key pairing”, where a first “key pair” can associate a user with a host (e.g., with a web service hosted by third-party server 400). In some embodiments, the host generates a second key pair. In some embodiments, ID sensor 255 records ID information 650, which is provided to the host. In some embodiments, a private key and/or a public key (e.g., keys of a key pair) can be transmitted to a user (e.g., user P) from a third party, such as third-party 3P, via authentication server 100, such as when the key is transmitted in multiple segments via multiple users, such as to a primary user P via one or more witnesses S, as described herein.

In some embodiments, user authentication is based on “state” information (e.g., the state of one or more user devices 200). For example, the state of a first and a second device, each of which is associated with the user, can be monitored by the host for a period of time to authenticate the user.

In some embodiments, data 120 comprises behavioral data related to a user. Authentication of a user can include providing ID information 650 comprising behavioral data that is compared to the previously recorded behavioral data to detect fraudulent behavior. For example, in some embodiments, a user can be authenticated based on their “use style” of user device 200 (e.g., based on how the user interacts with their cell phone, prior to and/or during an authentication process). In some embodiments, a MFA process is based on validation of biometric and behavioral factors.

In some embodiments, system 10 monitors user custody of a token 80, for example a monitoring that is performed after token 80 is created by a host and provided to the user. In some embodiments, the user is provided token 80, and provides the host with a demonstration of knowledge of token 80, such as a demonstration performed within a time frame of the creation of token 80, such as to authenticate the user's identity to the host. In some embodiments, token 80 can be transmitted to a user (e.g., user P) from a third party via authentication server 100, such as when token 80 is transmitted in multiple segments via multiple users, such as to a primary user P via one or more witnesses S, as described herein.

In some embodiments, user authentication is based on one or more images provided from a user device to the host. For example, secondary device 300 can take a picture of user device 200, for example when user device 200 is displaying a unique identifier provided by the host (e.g., third-party server 400), and secondary device 300 can provide the image to the host for authentication.

In some embodiments, one or more of the security codes (e.g., password 72 or token 80) of system 10 periodically change to help prevent fraudulent access to a host server. In some embodiments, security information (e.g., a security certificate) can be encrypted and/or decrypted with a public and/or private key.

In some embodiments, a MFA process is performed in real time, such as immediately prior to and or during a secure process (e.g., a secure transaction between user P and third-party 3P). In some embodiments, system 10 compares information from two or more applications (e.g., application 60) running on user device 200 to information stored on a server (e.g., data 120 and/or data 420).

In some embodiments, ID sensor 255 comprises an accelerometer, and ID information can include “micro acceleration biometric” data.

In some embodiments, a MFA process is based on one or more authentication rules.

In some embodiments, system 10 is configured to perform a “hidden” MFA process, for example where a user of system 10 provides invalid credentials and is allowed to access the host server (e.g., at least a portion of the host server, for example a limited functionality portion of the host server).

In some embodiments, ID sensor 255 comprises a capacitive area sensor.

In some embodiments, system 10 is configured to detect when a first device (e.g., user device 200) is wirelessly paired, such as via Bluetooth, to a second device, (e.g., a second user device 200, third-party device 400, and/or a secondary device 300).

In some embodiments, system 10 is configured to monitor one or more communication applications (e.g., text message and/or email) of a user of system 10 to identify when a security code (e.g., token 80) has been delivered to the user.

In some embodiments, system 10 is configured to determine if a user is human, such as by analyzing geographic and/or interaction data (e.g., ID information including geographic data and/or data relating to the interaction between user P and device 200).

In some embodiments, one or more devices of system 10 (e.g., user device 200 and/or secondary device 300) comprise one or more immutable hardware identifiers. In some embodiments, user authentication can be based at least in part on one or more of these identifiers.

In some embodiments, user device 200 includes a hardware token, such as a hardware key, for example a hardware key configured to wirelessly link (e.g., via NFC) to a cell phone or other device (e.g., another device belonging to user P).

In some embodiments, and as described in detail herein, system 10 can be configured to authenticate user P by having user P, secondary user S (e.g., a witness of the present inventive concepts), or both, perform an action using user device 200, secondary device 300, or both. The action can include user P and/or secondary user S performing a task that requires the screen of each of the user interfaces of both user device 200 and secondary device 300 (user interface 250 and user interface 350, respectively). For example, a cursor, icon, and/or other displayed graphic (“cursor” or “icon” herein) can be moved between a virtual screen (e.g., virtual screen 2541 described hereinbelow) comprising the two screens, such as to complete a task whose graphical information is presented on both screens (e.g., a maze or other movement task whose entirety requires both screens to be fully presented).

In some embodiments, and as described in detail herein, system 10 can be configured to authenticate user P by capturing one or more images (e.g., 3D facial data as described herein) of a secondary user S, and system 10 can confirm user S is the proper individual (e.g., not an imposter) via the images, such as when the secondary user S comprises one or more individuals functioning as a witness of authentication of user P. In these embodiments, system 10 can be further configured to capture one or more images of user P as well, and system 10 can confirm user P is the proper individual via the images. In some embodiments, system 10 is configured to operate in a “virtual world” (e.g., as described hereinbelow). System 10 can be configured to confirm the identity of user P, secondary user S, or both, in a virtual world, such as in a user confirmation that is performed relatively simultaneously. This confirmation can comprise each user performing a movement task including each user controlling a (separate) cursor, across the screens of each associated device (e.g., user interface 250 of user device 200 and user interface 350 of secondary device 300). The confirmation can include each user being recognized (e.g., confirmed) by the associated device via one or more facial or other images of the user recorded by that device (e.g., via a 3D camera), as described herein. One or both of user P and/or secondary user S can verify the other, such as via one or more tasks involving screens that are shared (e.g., image verification and/or task verification).

As described herein, system 10 can include one or more algorithms, algorithm 15. Algorithm 15 (e.g., the instructions stored in memory 112 for performing a routine) can comprise an algorithm that includes one or more biases, such as one or more biases that affect a determination made by algorithm 15. In some embodiments, algorithm 15 (e.g., when performed as a part of application 60) can comprise a bias that causes system 10 to tend away from an authentication that is a false authentication (e.g., a bias that causes system 10 to tend away from falsely confirming an imposter of user P). For example, if ID information 650 collected and analyzed by system 10 (e.g., analyzed by algorithm 15) is below a “threshold of certainty” that the user can be positively authenticated, algorithm 15 can be configured to not authenticate the user. In some embodiments, algorithm 15 can request additional ID information 650 be collected to confirm the authentication if the initial authentication is below a threshold of certainty. In some embodiments, the threshold of certainty can be adjusted (e.g., automatically adjusted by algorithm 15) based on the transaction and/or other action of high importance for which authentication is required (e.g., based on the level of trust needed to allow the transaction).

In some embodiments, system 10 is configured to provide a user, such as user P, with confidential information, such as a confidential code or password, “code” herein. For example, system 10 can transfer encrypted data to user P, and can also transfer decryption information (e.g., a decryption key), such as via the network of users (users P and S described herein). A third party, such as third-party 3P can utilize system 10 to transfer confidential information or other codes to user P via authentication server 100. In some embodiments, system 10 is configured to transfer a code from authentication server 100 (e.g., a code provided to authentication server 100 from third-party 3P) to user P in two or more parts or segments, “segments” herein. In some embodiments, system 10 is configured to identify the users (e.g., users P, S1, and S2) described herebelow, such as with one more of the methods described herein, prior to transferring confidential information to one or more of the users. In some embodiments, the code comprises an encryption key, an encryption code, a decryption key, and/or other encryption information that could otherwise be intercepted by a nefarious party if not transmitted in multiple segments to different users as described herein. In some embodiments, a first segment of a code is provided to a user, such as user P, locally, such as via wireless short range data transfer (e.g., a Bluetooth transfer), such as when user P is present at a third-party site, for example a bank or institution. In some embodiments, one or more of the segments and/or the code being transmitted is only valid (e.g., only valid to be used for future identification of the user possessing the complete code) for a limited period of time, such as no more than one week, no more than one day, no more than one hour, or no more than ten minutes.

Authentication server 100 can be configured to transmit information (e.g., one or more codes) in multiple segments, such as when each of the segments need to be combined for the information to be “understood” by user P, such as when each segment of the information comprises a portion of a decryption key. For example, authentication server 100 can transfer the first segment of the code directly to user P, via network 20, to user device 200. Authentication server 100 can transfer the second segment of the code to a first secondary user, user S1, such as a secondary user who is physically present with user P. Authentication server 100 can transfer the third segment (and final, in the case of a three-part code) to a second secondary user, user S2, such as an “anonymous witness” as described herein. User's S1 and S2 can provide the second and third segments of the code to user P, such that user P possesses all three segments of the code. In some embodiments, application 60 is configured to receive the second and third segments, such as via NFC transfer from user S1, and a message (e.g., a text message) received from user S2. User S2 can provide the third segment via encrypted and/or unencrypted means of communication (e.g., via text message or via an encrypted message function of application 60), as a single code segment alone would provide no “use” to a nefarious party without the first and second segments. For example, authentication server 100 transfers a segment of the code to a witness user, such as user S1 comprising an anonymous witness, and user S1 transfers the received segment to user P via a communication method of system 10 described herein, and/or via any communication method agreed upon by user P and user S1. For example, user S1 can call user P (e.g., a phone call), the users could meet at a physical location, such as the grocery store, and/or the users could meet virtually, such as in a video game, for example World of Warcraft. User S1 and user P can share the code segment freely (e.g., without the need for encryption) as described herein.

In some embodiments, one or more codes transferred from authentication server 100 to user P can be used by user P to verify their identity to a third party, such as third-party 3P, for example as a form of two-factor authentication (2FA). For example, third-party 3P can provide a code to authentication sever 100 via a secure encryption method (e.g., a method of system 10, or another encryption that is sufficient to the third party). Authentication server 100 can provide the code to user P using the segmented method described herein. User P can then provide the code back to third-party 3P, thus verifying the identity of user P to third-party 3P. In some embodiments, two, three, or more third-party entities are involved, such that once user P receives the code (e.g., from authentication server 100 via segmented transmission), user P can present that code to another third party to verify their identity.

In some embodiments, system 10 is configured to provide encrypted communications between two or more users and/or servers of the system using techniques similar to “frequency hopping”. For example, a first witness, such as an anonymous witness as described herein, can tell both authentication server 100 and user P which encryption method (e.g., which “frequency”) to use for a particular communication and/or transaction. For example, authentication server 100 can transmit two, three, or more indexed messages each comprising code segments to users P, S1, and S2 described herein. Each user can know (e.g., via a previously determined arrangement) which of the indexed messages comprises the correct code segment to deliver to user P such that user P can determine the proper code (e.g., by assembling the received segments).

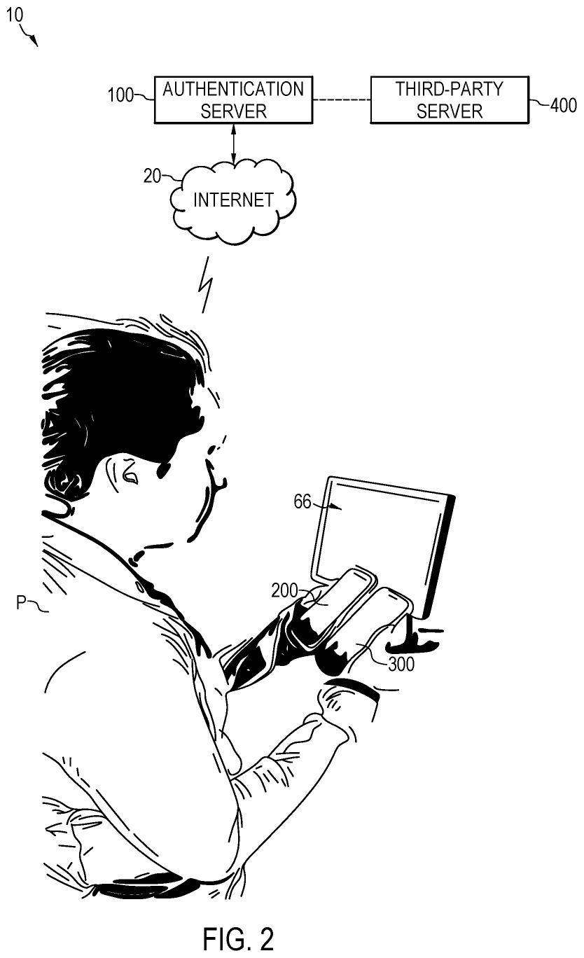

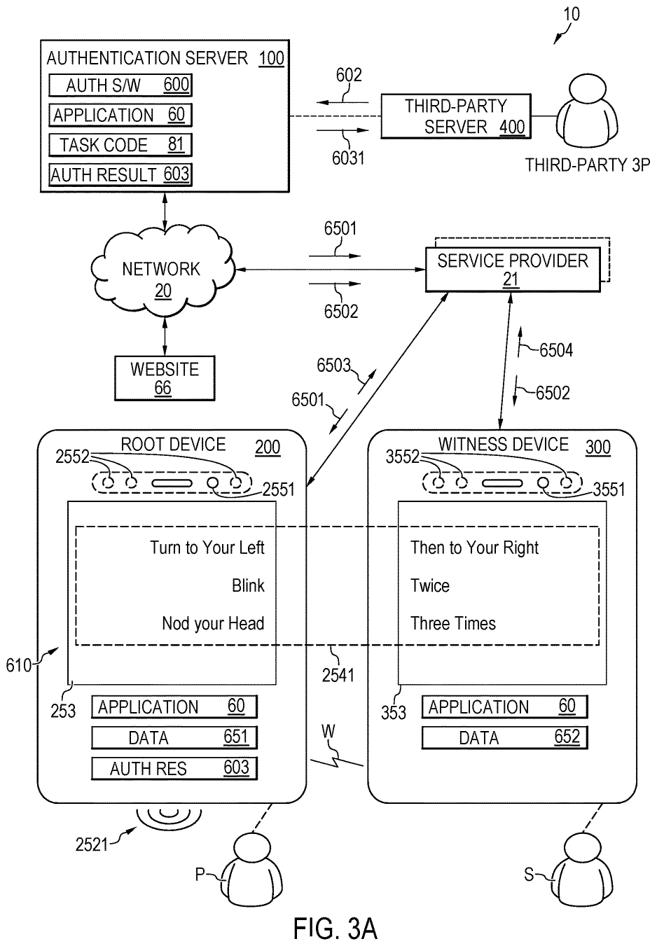

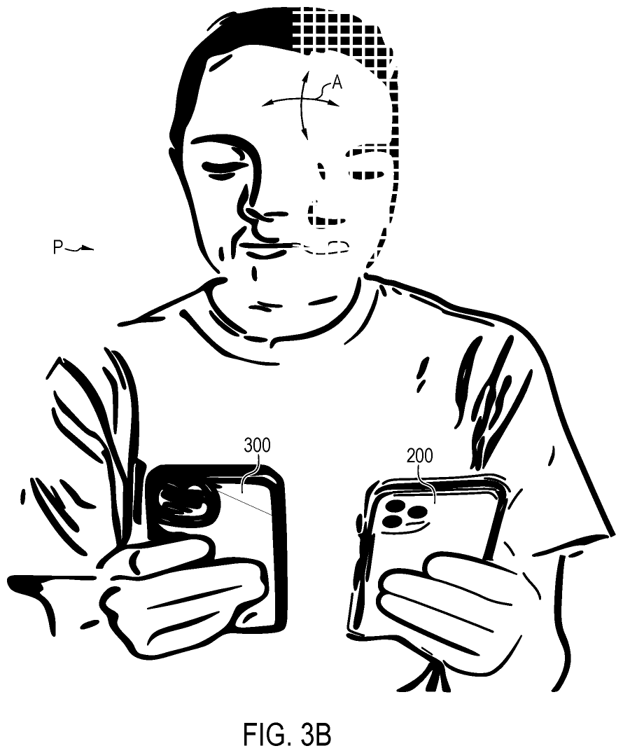

FIG. 2 shows one authentication witness system that provides an improved level of trust when authenticating a user P to an authentication server 100 to access a protected resource (e.g., a financial account, a transaction, a transfer, a document, a resource that controls an action of high importance, and the like), such as via a network-based interface, website 66, or other communication portal. FIG. 3A is a schematic block diagram illustrating system 10 of FIG. 2 in further example detail. FIG. 3B is a perspective illustrating head movement as user P performs an interactive authentication procedure, interactive task 610 of FIG. 3A. FIGS. 2, 3A, and 3B are best viewed together in the following description. System 10 of FIGS. 2, 3A and/or 3B can be of similar construction and arrangement as system 10 described in reference to FIGS. 1 and 1A.

Website 66 can be implemented by authentication server 100, and/or by a third-party server 400, that is accessed via network 20, such as the Internet. Network 20 can comprise any computer network, such as a public and/or private computer network, and/or a cellular network (e.g., a wired and/or wireless network of any configuration). In some embodiments, authentication server 100 and third-party server 400 can be co-located and/or have functionality combined in a single server. In other embodiments, third-party server 400 can use authentication server 100 as a service to provide a higher level of authentication of user P. User P has a root client device, root device 200, also referred to herein as user device 200, (e.g., a personal smartphone, a tablet computer, and/or similar device) that authenticates user P using a user recognition routine (e.g., a facial recognition routine) when authorizing access to that device. Root device 200 can be similar to user device 200 described in reference to FIG. 1 and otherwise herein. Additionally (e.g., at the same time), user P uses a witness client device, witness device 300, also referred to herein as secondary device 300, (e.g., a second smartphone, tablet computer, or similar device, belonging to another person, referred to herein as a “witness”; see for example secondary user S referred to in reference to FIG. 1 and otherwise herein) to witness the authentication. Witness device 300 can be similar to secondary device 300 described in reference to FIG. 1 and otherwise herein. As shown in FIG. 2, root device 200 and witness device 300 can be positioned adjacent one another such that a portion of the body of user P, such as the face of user P can be presented to each client device as shown. Root device 200 and witness device 300 can each run an application (e.g., an app downloaded to each client device; see for example applications 60 described herein) that is associated with authentication server 100 and that cooperate to collect user recognition data (e.g., facial, head, eye, arm, hand, leg, and/or other movement data, see for example data 651 and 652, FIG. 3A) of user P during the authentication, such as recognition data gathered in response to an interactive task (see for example interactive task 610, FIG. 3A) output by one or both of root device 200 and witness device 300. In some embodiments, two forms of movement data (e.g., facial movement and hand movement data) are used in authentication. Movement data (e.g., facial movement data and/or other movement data) and/or other recognition data can be independently received by authentication server 100 from both of root device 200 and witness device 300, and authentication server 100 can compare the recognition data to verify that both root device 200 and witness device 300 were present during the authentication of user P. The use of facial movement and/or other recognition data by authentication server 100 eliminates or at least reduces (“eliminates” or “prevents” herein) the possibility of fraud through subterfuge, such as spoofing, scamming, replicating, and/or other malicious attacks by a nefarious party. System 10 can also include “user liveness” tests to prevent the use of facial replicas (e.g., prevent a malicious attack using facial replicas). For example, during authentication, application 60 can detect one or more of blood flow and/or other physiologic parameter level, eye and/or eyelid movement, expression changes, and the like, as an indication of liveness of the individual being authenticated (the “user”, or user P), thereby preventing the facial replica from successfully authenticating.

By analogy, system 10 can thus be configured to provide a service similar to that provided by a notary public, where the witness (e.g., owner of witness device 300 and trusted to authentication server 100) performs additional verification (similar to the notary inspecting a driver's license or other document) of the identity of registered user P prior to authentication, at the request of authentication server 100. System 10 can also permit friends and/or family of registered user P to act as the witness and provide witness device 300 to witness authentication of user P to authentication server 100.

In some embodiments, one or more individuals acting as a witness (e.g., a witness to an authentication procedure described herein), witness S (also referred to herein as secondary user S), comprises one, two, or more individuals that are related to and/or otherwise acquainted with user P (e.g., a user P comprising one, two, or more individuals). Alternatively or additionally, witness S comprises one, two, or more individuals that: do not know user P; and/or are unknown to user P.

Authentication server 100 and/or third-party server 400 can be operated by an entity, such as third-party 3P described in reference to FIG. 1 and otherwise herein. Third-party 3P manages accounts for each of user P and witness S, such as when an improved level of trust in authentication of user P is required or at least desired. Third-party 3P can be, for example, a bank, an accountancy, a government organization, a document management company, and the like. In some embodiments, where authentication server 100 is independent of third-party server 400, authentication server 100 can provide an authentication service at a higher level of trust to third-party 3P. Functionality of authentication server 100 can alternatively be integrated with third-party server 400.

In FIG. 3A, when third-party server 400 requires a higher level of trust for authentication of user P, third-party server 400 can send a request 602 to authentication server 100; authentication server 100 in turn determines that a higher level of trust is needed to authenticate user P upon receipt of request 602. In some embodiments, such as when authentication server 100 and third-party server 400 are integrated together, authentication server 100 can determine that a higher level of trust is needed to authenticate user P based upon context of the access or service being requested by user P.

Authentication server 100 can comprise a server that is “in the cloud” and can communicate with root device 200 and witness device 300 via the network 20. Root device 200 and witness device 300 can also be configured to communicate independently with authentication server 100, such as via network 20 (e.g., via a cellular provider and/or the Internet). One or more devices of system 10 can communicate using network 20 (e.g., the Internet) via one or more service providers, such as an Internet service provider (ISP) and/or a cellular provider, service provider 21 shown. Root device 200 and witness device 300 can use the same cellular and/or other service provider 21 or different cellular and/or other service providers 21 without departing from the scope hereof. Importantly, communication between authentication server 100 and each of root device 200 and witness device 300 can occur independently of website 66: advantageously, this independent communication prevents any nefarious party who may attempt access to website 66 from detecting and interpreting communication between authentication server 100 and each of root device 200 and witness device 300.

Root device 200 and witness device 300 can each comprise a smartphone or other cell phone, tablet computer, and/or other similar device that can be configured to implement facial recognition as a way of access control. Root device 200 can be associated with (e.g., owned and/or operated by) user P, and witness device 300 can be associated with (e.g., owned and/or operated by) witness S. Accordingly, root device 200 and witness device 300 can each include at least one forward camera 2551 and 3551, and/or at least one projector/scanner 2552 and 3552, respectively. Projector/scanner 2552 and 3552 can comprise an infrared camera, a LiDAR sensor, and/or other component that can be configured to operate to capture depth information of a face presented to cameras 2551 and/or 3551. For example, first, a flood of infrared (IR) light can shine onto the face of user P and an infrared image can be captured. Then, multiple (e.g., more than 30,000) pinpoints of infrared light can be projected onto the face, and the infrared sensors can capture a depth field (3D data) of the face based upon detection of infrared light reflected from the face. Alternatively or additionally, non-infrared-based images and/or depth field data can be captured (e.g., via a non-infrared camera). The image and the depth field data can then be used together to authenticate the face to the client device based upon previous training of the facial detection, such as without storing facial images on the client device and/or other component of system 10, and without sending facial images over a network (e.g., the Internet), such as to a server or other memory storage device. Each root device 200 and witness device 300 can make this IR scanning and authentication functionality available to an application running on the client device. Further, the 3D facial data and images allow one, two, or more of facial expressions (e.g., blinking, winking, smiling, yawning, and the like), eye and/or eyelid movement, mouth movement, facial muscle movement, hand and/or arm movement, leg movement, and/or head movement (e.g., turning left and right, nodding, and the like) to be detected (e.g., and used in authentication as described herein). In some embodiments, motion of one, two, or more other body parts of the user are imaged, and data collected for user authentication. Advantageously, this 3D detection and authentication functionality is part of each root device 200 and witness device 300 and is used by application 60 on both root device 200 and witness device 300 to authenticate, and/or capture movement of, user P, such as when performing a randomly selected and/or generated interactive task 610.

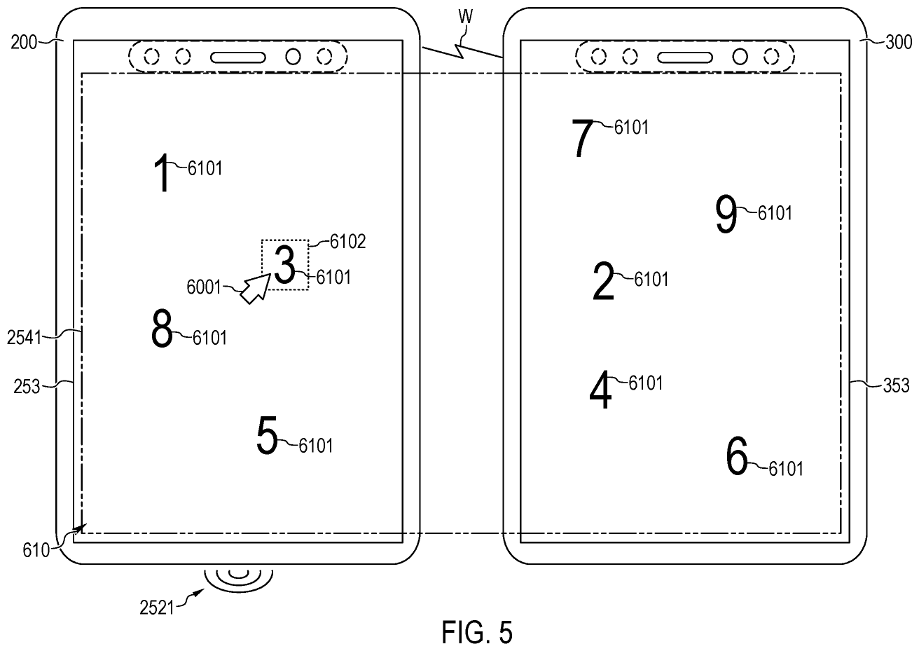

Interactive task 610 can be a randomly selected task (e.g., challenge) for user P to perform as part of authentication, and interactive task 610 can require user P to make predefined movements (e.g., facial movements, head movements, hand movements, or two or more of these) that are detectable by both root device 200 and witness device 300. For example, interactive task 610 can comprise a game, a maze puzzle, a sequence of on-screen facial movement directives, a sequence of audible facial movement directives, a series of consecutive non-repeating single digit numbers randomly distributed across displays of both the root and the witness client devices, and/or other user performable tasks. In some embodiments, interactive task 610 comprises two, three, or more tasks (e.g., two, three, or more of those listed immediately hereinabove). Interactive task 610 can be configured to require user P to make one or more movements (e.g., eye and/or eyelid movements, mouth movements, facial muscle movements, other facial movements, head movements, finger movements, hand movements, arm movements, and/or other body part movements) such as to control a cursor (see for example cursor 6001 in FIG. 5) to complete interactive task 610. Interactive task 610 need not control a cursor though; it can simply direct the user (e.g., direct attention, such as eye gaze or head position, of the user) between root device 200 and witness device 300. As shown in FIG. 3B, for example, user P may turn their head, as indicated by arrows A, when performing interactive task 610, and each of root device 200 and witness device 300 can independently track and capture movement of user P as movement data 651 and 652, respectively. Movement data 651 and/or 652 can comprise one or more forms of user P movement, such as movement selected from the group consisting of: head movement; eye and/or eyelid movement; mouth movement; lip movement; tongue movement; ear movement; facial muscle movement; arm movement; hand movement; finger movement; limb movement; other body part movement; and combinations of one, two, or more of these. In another example, user P uses body part movement (e.g., head movement and/or head position, eye movement, hand movement, and the like) to control a cursor that pushes an object between displays 253 and 353 (e.g., a display of user interface 350 of witness device 300 described herein) of root device 200 and witness device 300, respectively. In some embodiments, two or more pre-determined forms of movement are associated with a particular user P, and system 10 is configured to identify the forms of movement used, and to confirm the proper forms of movement were used as part of the authentication process (e.g., if improper forms of movement are used authentication is not confirmed). To implement interactive task 610, root device 200 and witness device 300 can cooperate, such as by using wireless connectivity W (e.g., one or more of Wi-Fi, Bluetooth, near-field, and the like) to coordinate movements of a cursor and/or objects between displays 253 and 353 as described herein.

Authentication server 100 comprises, for example, a computer that includes at least one processor and memory that stores various software of system 10 as machine readable instructions that, when executed by the processor, causes the processor to perform one or more routines and/or algorithms (“routines” or “algorithms” herein), such as a routine and/or algorithm that performs witness authentication of user P. For example, system 10 can include one or more applications, application 60, such as one or more applications comprising one or more routines for authenticating a user, such as authentication software 65. Application 60 and/or authentication software 65 can cause one or more of the devices of system 10 to perform one or more algorithms 15, as described herein. Authentication server 100 can be associated with an application 60 that can be downloaded to and executed by each of root device 200 and witness device 300. For example, to avail themselves of the advanced security provided by system 10, authentication server 100 can instruct user P and witness S to download and install application 60 to root device 200 and/or witness device 300, respectively. Application 60, once installed, can register itself, and thus the client device on which it is installed, with authentication server 100, where it can be associated with one, two, or more corresponding accounts. For example, root device 200 can be associated with one, two, or more accounts of user P and witness device 300 can be associated with one, two, or more accounts of witness S. Accordingly, authentication software 600 can look up each of root device 200 and witness device 300 from the accounts stored in a database (e.g., as data 120) when its associated user attempts to log in to website 66 and provide a login name and/or an account ID.

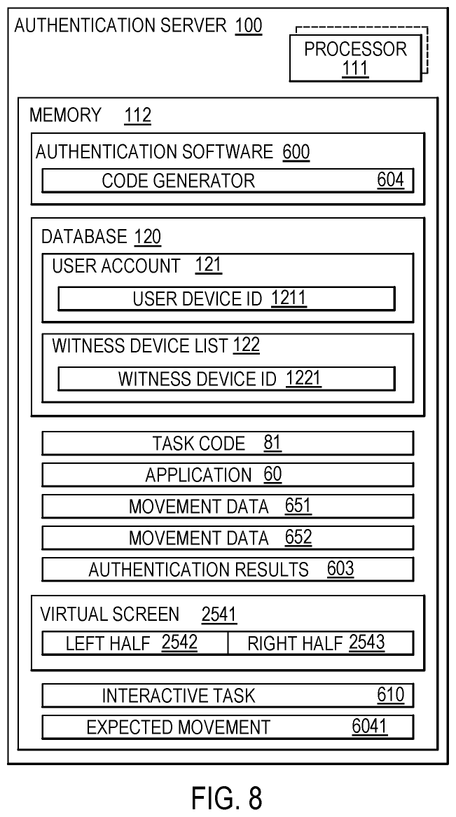

Authentication software 600 can be configured to open a communication channel with each of root device 200 and witness device 300. For example, authentication software 600 can send messages 6501 and 6502 (e.g., notifications and/or requests) to root device 200 and witness device 300, respectively, that cause each client device to start application 60 when it is not already running. Message 6501 can instruct application 60 running on root device 200 that it is to be configured as the root client device, and message 6502 can instruct application 60 running on witness device 300 that it is to be configured as the witness client device. Accordingly, although root device 200 and witness device 300 can each run the same application 60, application 60 can configure its behavior according to the received message 6501 and 6502, respectively. Message 6501 can identify (e.g., via a MAC address) witness device 300 and message 6502 can identify (e.g., via a MAC address) root device 200, such that application 60 can cause root device 200 and witness device 300 to communicate and synchronize with one another. Messages 6501 and 6502 can also include one or more tokens, such as token 80 described herein, such as a task code 81, such as a task code 81 that is randomly generated (e.g., by authentication server 100) and can be used by each application 60 to determine an interactive task 610 that is to be performed by user P (e.g., determine one, two, or more interactive tasks 610 that are to be performed by user P). Task code 81 can be a random alphanumeric designation (e.g., a number) and/or a random seed that is used by application 60 to determine one or both of a type of interactive task and/or a content of the interactive task. Particularly, task code 81 can be configured to allow authentication software 600 to know which of many different and/or varied interactive tasks (e.g., interactive task 610) is to be performed by user P, and interactive task 610 can be configured such that it cannot be predicted, for example since task code 81 is unpredictably and randomly generated and/or part of a pseudo-random sequence known only to authentication software 600. Further, task code 81 can be delivered directly to each of root device 200 and witness device 300, and, for example, not via website 66; thus, a nefarious party attempting to use website 66 maliciously cannot easily intercept task code 81. Application 60 can be periodically updated to interpret task code 81 differently from a previous version, such that even if task code 81 were intercepted, its meaning and interpretation can change over time, making it even less predictable. In some embodiments, task code 81 changes over time. In some embodiments, task code 81 defines randomness in the content of interactive task 610, but the type of interactive task 610 is randomly selected by application 60 running on one of root device 200 or witness device 300, sent to the other of witness device 300 or root device 200, respectively, and sent to authentication server 100 with movement data 651 and 652 and/or authentication result 603 (e.g., in one of messages 6503 and 6504). Accordingly, authentication server 100 can be configured to determine expected movement (e.g., expected movement 6041 of FIG. 8) of user P when performing interactive task 610. Alternatively, task code 81 may only define the type of interactive task 610, and one of root device 200 and witness device 300 can be configured to randomly generate the content of interactive task 610 and inform the authentication server 100 thereof.

On witness device 300, application 60 can be configured to require witness S to authenticate and verify that witness S is present. That is, witness S can authenticate on witness device 300, such as by presenting their face to the forward-facing camera 3551 of witness device 300, and/or by one, two, or more other identification routines, such as are described herein. If the authentication of witness S on witness device 300 fails, application 60 can terminate. If authentication of witness S is successful, application 60 can output directions from witness device 300 that it should be provided to (e.g., handed to) user P. On root device 200, application 60 can output directions that user P should request witness device 300 from witness S. User P can then hold root device 200 and witness device 300 adjacent to one another, such as is shown in FIG. 2.

Application 60 can control each of root device 200 and witness device 300, such as to communicate and cooperate with one another (e.g., to communicate via network 20). For example, root device 200 and witness device 300 can each enable a wireless protocol (e.g., a Bluetooth wireless protocol) to form a communication channel (e.g., network 20 can comprise a Bluetooth network). In another example, where root device 200 and witness device 300 are each connected to the same Wi-Fi hub, root device 200 and witness device 300 can form a Wi-Fi communication channel (e.g., network 20 can comprise a LAN). In another example, root device 200 and witness device 300 can communicate through service provider 21 (e.g., communicate over the Internet through service provider 21), and/or a network provided by authentication server 100. Other short-range wireless protocols can be used to enable communication between root device 200 and witness device 300 without departing from the scope hereof.

Root device 200 and witness device 300 can then cooperate to interact with user P and provide witnessed authentication to authentication server 100. In a first step, one or both of root device 200 and witness device 300 can generate interactive task 610 based upon task code 81 received in messages 6501 and 6502. Applications 60 can cooperate to present the user a graphical user interface (e.g., GUI 254) spanning multiple devices, virtual screen 2541 shown. Virtual screen 2541 can be formed by (e.g., can comprise) at least a part of each display 253 and 353 of root device 200 and witness device 300, respectively. Particularly, interactive task 610 can be spread across (e.g., require a cursor to move across both of) displays 253 and 353 of root device 200 and witness device 300, thereby requiring that both client devices are present and cooperating to allow user P to correctly perform interactive task 610.

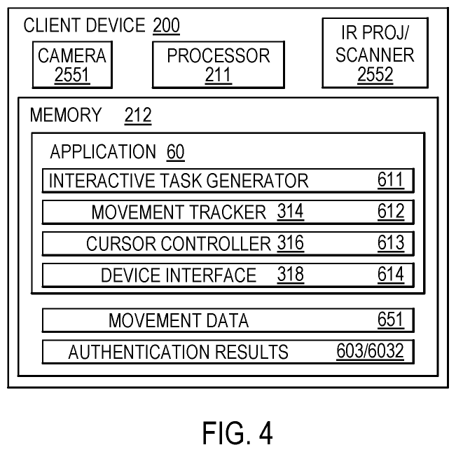

In some embodiments, as expressly shown in FIG. 3A, interactive task 610 is formed (e.g., presented or otherwise provided) as text that instructs user P to perform certain tasks (illustratively shown in FIG. 3A as “Turn to your left, blink, nod your head”). These instructions can be presented on virtual screen 2541 that is formed by at least part of each of the displays 253 and 353 of root device 200 and witness device 300 respectively. These lines of text can be presented one at a time. Alternatively or additionally, the instructions are provided as an audible output, audio 2521 shown, for example, when the text is read by Siri or other virtual assistant from one or both of root device 200 and witness device 300. Both of root device 200 and witness device 300 capture user P movements (e.g., facial movements and/or other movements) as user P performs interactive task 610. Root device 200 captures movement data 651 that defines only movements (e.g., facial movements, facial expressions, and/or other movements) detected by root device 200. Using the same hardware and/or software that facially authenticates user P, movement tracker 612 (in FIG. 4) can capture movements (e.g., head movements, hand movements, and/or facial expressions) made by user P, such as through use of the IR projector/scanner 2552 and/or camera 2551. Witness device 300 can capture movement data 652 that defines only movements detected by witness device 300. In some embodiments, movement data 651 and 652 do not contain biometric images and/or other sensitive information that can be used to identify user P (e.g., data that can be used to identify user P can be removed from movement data 651 and 652). Further, at one or more times (e.g., at the beginning, midway through, and/or at the end) during capture of movement data 651 and 652, while user P responds to interactive task 610, application 60 can cause root device 200 to authenticate user P using a user recognition routine (e.g., a facial recognition routine and/or a physiologic parameter recognition routine, such as are described herein).

When interactive task 610 is complete, root device 200 can be configured to send a message 6503 to authentication server 100 containing results of the one or more authentications (e.g., user recognition routines) performed by root device 200 during interactive task 610 and movement data 651, and witness device 300 can be configured to send a message 6504 to authentication server 100 containing movement data 652.

Authentication software 600 can process messages 6503 and 6504 to determine authentication results 603 that indicate whether access to website 66 (or the protected resource, transaction, transfer, document, action of high importance, and the like to be performed and/or delivered) is granted for user P. First, authentication software 600 evaluates the results of authenticating user P during interactive task 610, received in message 6503, to determine a first level of trust. Then, authentication software 600 compares movement data 651, received in message 6503, to movement data 652, received in message 6504, to determine whether both root device 200 and witness device 300 were present during the authentication and interactive task 610. For example, when both root device 200 and witness device 300 are facing user P, each client device can capture substantially the same movements as user P follows interactive task 610, and these movements defined by movement data 651 should be very similar to movements defined by movement data 652. Slight variances are expected and can be allowed (e.g., via an algorithm of system 10), such as variances due to the slight positional and angular differences between root device 200 and witness device 300 relative to user P. Authentication software 600 can also compare these detected movements to expected movements corresponding to task code 81. For example, the sequence and direction of movements detected and stored within movement data 651 and 652 should be similar to expected movements defined by the interactive task 610 corresponding to task code 81. In some embodiments, certain timing differences between expected movements and the movement data 651 and 652 are ignored (e.g., via an algorithm 15 of system 10), however timing of movements between movement data 651 and movement data 652 is not ignored. Thus, a malicious “replay attack” (e.g., by a nefarious party) where previously captured messages 6503 and 6504 are resent to authentication server 100 will not match expected movements, since task code 81 is regenerated for each two-device authentication attempt, and thus the expected movements will not be the same. Accordingly, authentication software 600 is configured to detect (e.g., is not fooled by) replay attacks, making subterfuge significantly more difficult.

Authentication software 600 can be configured to send a message 6031 to third-party server 400 indicating a result (success or failure) of a witnessed authentication of user P, where success indicates that user P was successfully authenticated on root device 200, the captured movement data 651 matches movement data 652 to indicate that witness device 300 was present to witness the authentication, and that one or both of movement data 651 and 652 matches expected movement (see for example expected movement 6041 in FIG. 8) corresponding to interactive task 610 to indicate that user P performed the interactive task 610. Success of all evaluations by an authentication routine of authentication software 600 indicates a higher level of trust that user P is who they claim to be.

FIG. 4 is a block diagram illustrating an example user device, such as root device 200 and/or witness device 300 described in reference to FIG. 1 and otherwise herein. User device 200 of FIG. 4 is an example of both root device 200 and witness device 300 and includes at least one processor 211 communicatively coupled with a memory 212 that stores application 60 as machine readable instructions executable by processor 211 to provide functionality of user device 200 as described herein (e.g., perform one or more algorithms or routines as described herein). Memory 212 can store instructions for performing one or more algorithms (e.g., algorithm 15) of system 10. In some embodiments, application 60 includes a plurality of modules including an interactive task generator 611, a movement tracker 612, a cursor controller 613, and/or a device interface 614. Interactive task generator 611 can be configured to implement one or more algorithms and/or routines that cooperate to generate interactive task 610 based upon task code 81 received via one of messages 6501 and 6502 from authentication server 100. Interactive task generator 611 can generate interactive task 610 from the perspective of one of root device 200 and/or witness device 300, such as when the corresponding part of interactive task 610 for virtual screen 2541 is generated. Movement tracker 612 captures interactive movement data 651/652, according to whether application 60 is running as the root or witness device.

Cursor controller 613 can detect movement of user P to control movement of a cursor (e.g., see cursor 6001, FIG. 5), and/or any object, on virtual screen 2541. For example, cursor controller 613, when running on root device 200, can control movement of the cursor or other object (“cursor” herein) on root device 200, and when running on witness device 300, can control movement of a cursor on witness device 300. In some embodiments, cursor controller 613 detects a head-position and/or eye position of user P, relative to root device 200, to control movement of a cursor on the display of the client device. Accordingly, cursor controller 613 can determine from the head-position and/or eye position when the focus of user P is on the respective display 253 or 353, of root device 200 and witness device 300. In such embodiments, cursor controller 613 can implement a head-controlled cursor solution similar to HeadGaze by eBay, where the cursor position is determined via facial tracking and head movement. eBay's HeadGaze is an open-source library released by eBay to allow developers to use facial movement recognition in applications that they develop as an alternate navigation option for users with physical disabilities, for example. In other embodiments, cursor controller 613 can implement eye-tracking where eye movements and/or eye-positions of user P are used to control the movements of the cursor. In these embodiments, the eye movements can also be captured by movement tracker 612. Accordingly, cursor controller 613 can determine from the eye-movement and/or eye-position when the focus of user P is on the respective display 253 or 353, of root device 200 and witness device 300. Alternatively or additionally, hand movement, arm movement, and/or other body movement can be captured by cursor controller 613 and/or movement tracker 612.

Device interface 614 can be configured to allow root device 200 to cooperate with witness device 300 during witnessed authentication and participation of user P in interactive task 610. Accordingly, device interface 614 can allow root device 200 and witness device 300 to cooperate to perform the witnessed authentication of user P. As noted hereinabove, root device 200 and witness device 300 can communicate via one or more of Bluetooth, Wi-Fi, cellular protocols, and/or other wired and/or wireless communication arrangements.

In some embodiments, cursor controller 613 operating on each device 200 and/or 300 can cooperate, via device interface 614, to control cursor movement relative to virtual screen 2541, such that the cursor can move between displays 253 and 353 of root device 200 and witness device 300. Alternatively or additionally, cursor controller 613 running on each of root device 200 and witness device 300 can independently control the cursor when positioned on respective displays 253 and 353. For example, cursor controller 613 can detect when the head (or face) of user P points towards the display of that client device and thereby only controls the cursor of that display when attention of user P is actively directed towards that client device. When the head (or face) of user P is not pointing towards the display of that client device, the cursor can be hidden. Accordingly, the cursor appears to move between client devices. In some embodiments, cursor controller 613 can operate only on one of root device 200 and witness device 300 to detect movements of user P, and can share, via device interface 614, detected movements with the other client device. However, independently of whether control of the cursor is by cursor controller 613 running on one or both of root device 200 and witness device 300, movement tracker 612 on each of root device 200 and witness device 300 can independently capture movement data 651 and/or 652. Accordingly, movement data 651 and/or 652 includes movements of user P throughout participation in interactive task 610 from the perspective of the respective one of root device 200 and witness device 300.

Although root device 200 is illustrated on the left of witness device 300 in FIGS. 2, 3A, and 3B, positioning of root device 200 and witness device 300 can be reversed (e.g., root device 200 can be on the right of witness device 300). Device interface 614, running on each of root device 200 and witness device 300 can determine which protocols are available and best suited for intra-device communication. Device interface 614 can then allow application 60, through use of movement tracker 612 and/or cursor controller 613 on each of root device 200 and witness device 300 to synchronize with each other to perform the witnessed authentication.

FIGS. 5, 6, and 7 show three different example types of interactive task 610 that can be generated from task code 81 by application 60 running on both root device 200 and witness device 300. In the example of FIG. 5, interactive task 610 is a “number selection” type of task where information (e.g., audio information, audio 2521 shown), generated by interactive task generator 611 from task code 81, is output by application 60 to direct user P to move a cursor 6001, using head, eye, hand (e.g., one or more hands, and/or one or more fingers of one or more hands), and/or other movements detected by cursor controller 613, to highlight one or more numbers (e.g., letters, images, and/or other selectable icons, “numbers”, “images” or “icons” herein) included in the information provided (e.g., announced in audio 2521). Interactive task generator 611 uses task code 81 to determine a location for each of a plurality of numbers 6101 across virtual screen 2541. Accordingly, certain numbers in the sequence are shown on display 253 of root device 200 and other numbers of the sequence are shown on display 353 of witness device 300. In this example, user P is required to move cursor 6001 between displays 253 and 353 to select the provided numbers. User P can be instructed (e.g., via audio 2521 or otherwise) to interactively select at least two of the numbers shown on displays 253 and 353 in ascending numerical order by moving their head to control cursor 6001. As cursor 6001 is near one of the numbers 6101, it can be highlighted, for example as indicated by dashed box 6102, and the number can be selected, such as by the user P keeping the number highlighted for a predefined number of seconds (e.g., between 1 and 5 seconds). This cursor control and number selection requires no conventional selection using a finger or stylus. The instructions for which numbers to select and in which order can be generated from task code 81, and/or can be provided separately from authentication server 100. In some embodiments, different sets of text (e.g., alphanumeric text), symbols, shapes, images, and/or colors can be used in place of numbers.

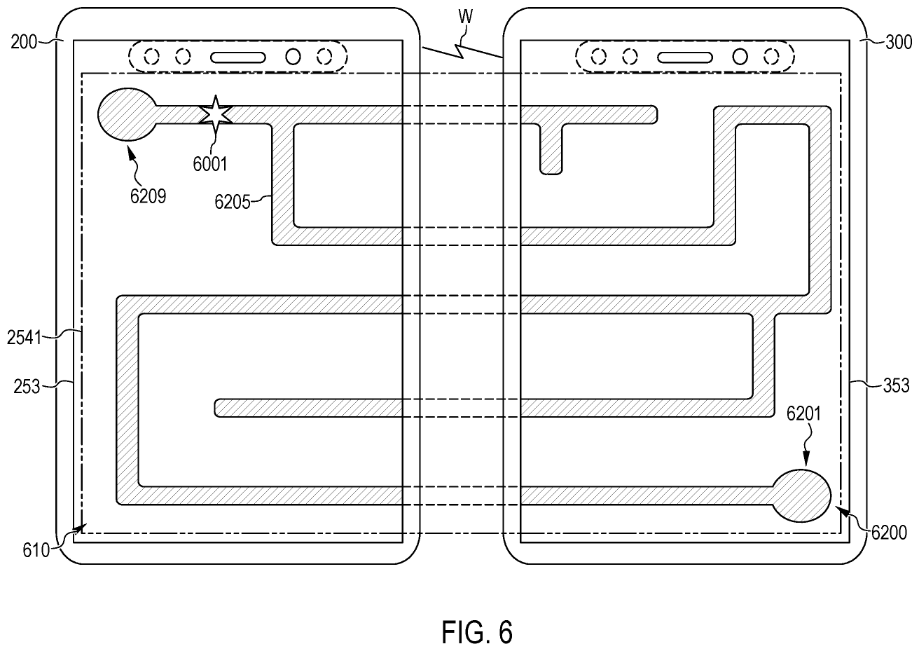

FIG. 6 shows an example maze type of interactive task 610 that can be generated by interactive task generator 611 from task code 81. In this example, virtual screen 2541 presents a maze 6200, spread across both displays 253 and 353, with a start 6201 and an end 6209, and at least one path 6205 connecting them together. User P, using head, eye, hand, and/or other movements, controls a cursor 6001 to follow path 6205 from start 6201 to end 6209. Movement and/or facial expressions of user P can be independently captured by movement tracker 612 in each of root device 200 and witness device 300 to create movement data 651 and 652, respectively, as user P performs interactive task 610. In another example, interactive task 610 is a game that user P plays using head, eye, hand, and/or other movements. For example, interactive task 610 can be a game similar to one or more of the arcade games “pong,” “breakout,” “space invaders”, and/or “missile command”, where head, eye, hand, and/or other movement of user P controls movement of one or more paddles or blasters between displays 253 and 353 to play the game.

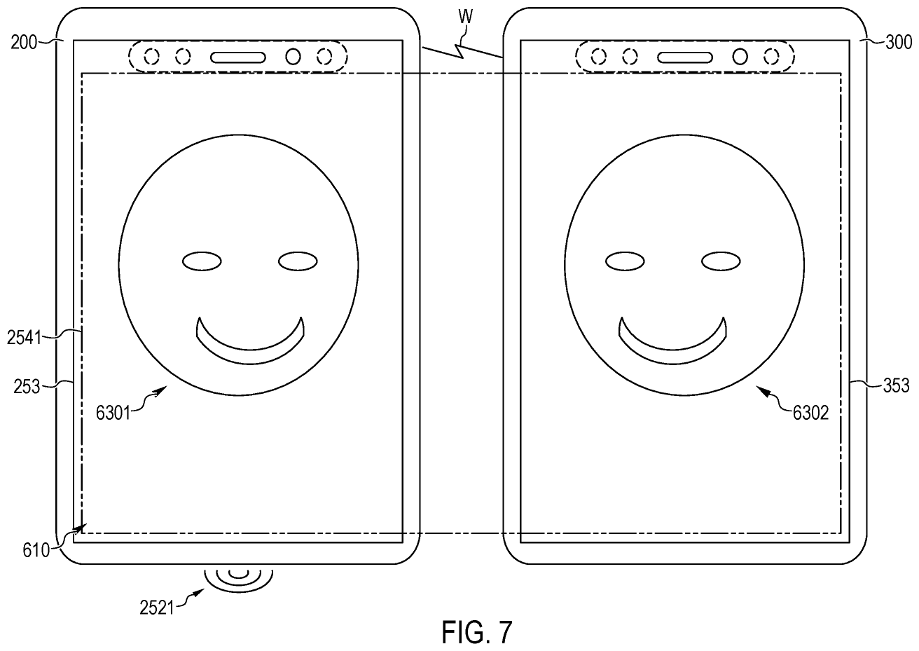

FIG. 7 shows another example interactive task 610 that can be generated by interactive task generator 611 from task code 81, where user P follows instructions (e.g., provided in audio 2521), such as to make facial expressions (e.g. a smile as shown) and/or other user-producible actions as defined by the instructions, wherein the actions are captured by movement tracker 612. These instructions can be generated from task code 81, and/or can be received separately from authentication server 100. This example is similar to the example of FIG. 3A, except that instructions for user P to follow can be output as audio 2521 and/or each of root device 200 and witness device 300 can display an animated avatar 6301 and 6302 generated from the captured movements, and stored as movement data 651 and 652, respectively. Since cameras 2551 and 3551 and IR projector/scanner 2552 and 3552 of root device 200 and witness device 300, respectively, have slightly different perspectives of user P, avatars 6301 and 6302 will be similar to each other, but not exactly the same.

FIG. 8 is a high-level block diagram illustrating authentication server 100 of FIGS. 1, 2 and 3A, and otherwise herein in further example detail. Authentication server 100 can include at least one processor 111 communicatively coupled with memory 112 that includes authentication software 600, which can be implemented as machine readable instructions executable by the at least one processor 111, and a database 120. Database 120 can store a user account 121 that can include login details (e.g., a username and/or account number) of user P and an associated user client device identification (ID) 1211 that includes an address (e.g., a MAC address, a URL, a telephone number, and/or other connectivity details) of root device 200. Database 120 can also store a witness client device list 122 that includes a witness client device identification 1221 that can identify one or more devices 200 and/or 300 that, such as through prior agreement, act as witness to any needed authentication. In some embodiments, witness client device list 122 can be part of user account 121, whereby witness client device ID 1221 identifies witness device 300 when witness S has previously agreed to (e.g., been configured to) be a witness specifically for user P. In another example, root device 200 can send witness client device ID 1221 to authentication server 100. For example, user P can ask a family member, friend and/or colleague to witness the authentication. Witness client device ID 1221 can include an address (e.g., a MAC address, a URL, a telephone number, and/or other connectivity details) of witness device 300. Accordingly, authentication software 600 can independently identify root device 200 and witness device 300 based upon details of user P (e.g., username and/or account number). In some embodiments, authentication software 600 can select witness client device ID 1221 from witness client device list 122, based upon one or more criteria, such as a level of trust in witness S, a current location of root device 200, and/or a current location of witness device 300, where the location of root device 200 and/or witness device 300 is determined by one or more of GPS (such as at the same locale), by same local network connection (e.g., same Wi-Fi), and the like. In another example, user P selects witness device 300 through proximity, whereby application 60 running on root device 200 uses near-field wireless communication to receive witness client device ID 1221 from witness device 300 and sends witness client device ID 1221 to authentication software 600.

Authentication software 600 can include a code generator 604 that is invoked when a request to authenticate user P is received. In some embodiments, code generator 604 generates task code 81 such that interactive task 610 (e.g., instructions to perform interactive task 610) appears to user P to have been randomly generated. In some embodiments, task code 81 is a pseudo-random number. In other embodiments, task code 81 is formed of more than one pseudo-random number, such as where a first part of task code 81 defines a type of interactive task 610 and where a second part of task code 81 defines content for that type of interactive task 610. Accordingly, code generator 604 generates task code 81 such that interactive task 610 at least appears to be selected at random. For example, code generator 604 can generate virtual screen 2541 and user instructions for interactive task 610 corresponding to task code 81. Virtual screen 2541 can comprise left half 2542 and/or right half 2543 as shown. In some embodiments, root device 200 comprises left half 2542 and witness device 300 comprises right half 2543, such as when root device 200 is positioned to the left of witness device 300, and vice versa. Code generator 604 can then generate an expected movement 6041, based on virtual screen 2541 and the instructions for example, that predicts movement of user P when performing interactive task 610. That is, expected movement 6041 defines a movement pattern to which movement data 651 and 652 is expected to conform to when user P performs interactive task 610. For example, where interactive task 610 uses numbers 6101 and head-based movement of cursor 6001, as shown in FIG. 5, expected movement 6041 can define expected head, eye, hand, and/or other movements of user P to control cursor 6001 to select numbers 6101 based upon the generated position of numbers across virtual screen 2541 and the generated order of number selection. Since interactive task 610 is generated at random, code generator 604 can use an intelligent algorithm (e.g., machine learning, neural net, and/or other AI algorithm, such as algorithm 15 described herein) to generate expected movement 6041 based on task code 81. For example, based upon a sample of captured movements of a plurality of test subjects performing randomly generated interactive tasks, code generator 604 uses the gained knowledge of captured head, eye, hand, and/or other body part movement and cursor control to predict expected movement 6041 for any future task code 81.

In some embodiments, where authentication server 100 provides witnessed authentication as a service to third-party server 400, authentication software 600 can receive a request to authenticate user P at a higher level (e.g., a higher level of security) from third-party server 400, and/or from a website 66 thereof. In alternative or additional embodiments, such as when authentication server 100 and third-party server 400 are integrated, authentication software 600 can determine, based upon the requested access to user account 121 and/or the transaction request that user P has requested, that a higher level of authentication of user P is required. For both embodiments, authentication software 600 can initiate authentication of user P by invoking code generator 604 to generate task code 81, and authentication software 600 can look up user P in database 120 to identify root device 200 and witness device 300 based upon user client device ID 1211 and witness client device ID 1221, respectively.

Authentication software 600 can be configured to then send messages 6501 and 6502, each including task code 81, to root device 200 and witness device 300, respectively, such that application 60 runs on each of root device 200 and witness device 300. In response, authentication software 600 can receive message 6503 containing authentication results 603 and movement data 651 from root device 200, and can receive message 6504 containing movement data 652 from witness device 300. Authentication software 600 can then determine whether authentication results 603 indicate that the facial authentication of user P on root device 200 was successful, compare movement data 651 to movement data 652 to determine whether the authentication was successfully witnessed, and then determine whether interactive task 610 was performed correctly by comparing one or both of movement data 651 and movement data 652 to expected movement 6041. Accordingly, authentication software 600 verifies that user P authenticated successfully to root device 200, that witness device 300 was present and witnessed the authentication, and that the performance of interactive task 610 by user P was for the current interactive task 610 (e.g., was not a replay of a recording of a previous interactive task).

Authentication software 600 can use and/or include one or more algorithms to evaluate movement 651 and 652 against expected movement 6041. For example, one algorithm can filter movement data 651 and/or 652 to determine an average head, hand, and/or other body part movement of user P for comparison to expected movement 6041. In another example, authentication software 600 includes an AI algorithm (e.g., algorithm 15 of system 10 described herein) that evaluates characteristics of head, eye, hand, and/or other body part movement in movement data 651 and/or 652 against previous captured movement characteristics of user P and the algorithm can be configured to identify anomalies when characteristics do not match. For example, if user P has a nervous twitch, tremor, head slant, and/or other relatively unique physiologic characteristic as a previous noted (e.g., and recorded) characteristic that is absent in movement data 651 and/or 652, authentication software 600 can determine that user P is not who they are claiming to be and authentication can be denied. In another example, authentication software 600 can evaluate a speed at which user P responds to prompts and/or other stimuli and compare those response time characteristics to previously captured characteristics. Accordingly, successful authentication of user P has a higher level of trust as compared to conventional single device authentication. Numerous forms of user characteristics can be utilized (e.g., recorded and compared to a previous recording or other standard) by authentication software 600 in one or more authentication routines.

Authentication software 600 affords a level of trust to authentication of user P to root device 200 and increases the level of trust in view of trust in witness device 300. That is, since it is less likely that both root device 200 and witness device 300 are simultaneously compromised, by using both client devices trust in the authentication is increased above the trust of a single client device. In some embodiments, witness device 300 comprises two, three, or more devices. Particularly, based upon the selection of witness device 300, higher levels of trust can be achieved. For example, a higher level of trust in authentication can be achieved when witness device 300 (e.g., one, two, or more devices) and witness S (e.g., one, two, or more individuals) are selected with a known higher level of trust, such as when witness S is at least a bank manager or other known-to-be trusted person or position, as opposed to a witness S comprising a single individual simply selected by being a person nearby. In certain circumstances, a higher level of trust is achieved when user P is known to witness S (e.g., known to at least one witness S), since witness S would know when user P is an imposter. When user P is not known to witness S, witness S is unable to guarantee that user P is who is claimed to be, such as when a SIM exchange has occurred within root device 200. On the other hand, where witness S is confirmed as belonging (e.g., at least one witness S is confirmed as belonging) to a trusted organization (e.g., Uber, UPS, FedEx, and any company/organization that registers and tracks a smartphone and/or computer of the user on the company's database) or is a notary, or someone from a legal office, or someone at hotel reception, for example, authentication server 100 can have more trust in witness S, and therefore can have more trust in the witnessed authentication of user P by witness S, even though user P is not known to witness S. Such witnessed authentication where user P is unknown to witness S can occur more frequently when user P is traveling, for example.

In some embodiments, authentication server 100 can also store, and make available for download, a copy of application 60. In some embodiments, application 60 can be made available for download from other servers (e.g., App stores, and the like).

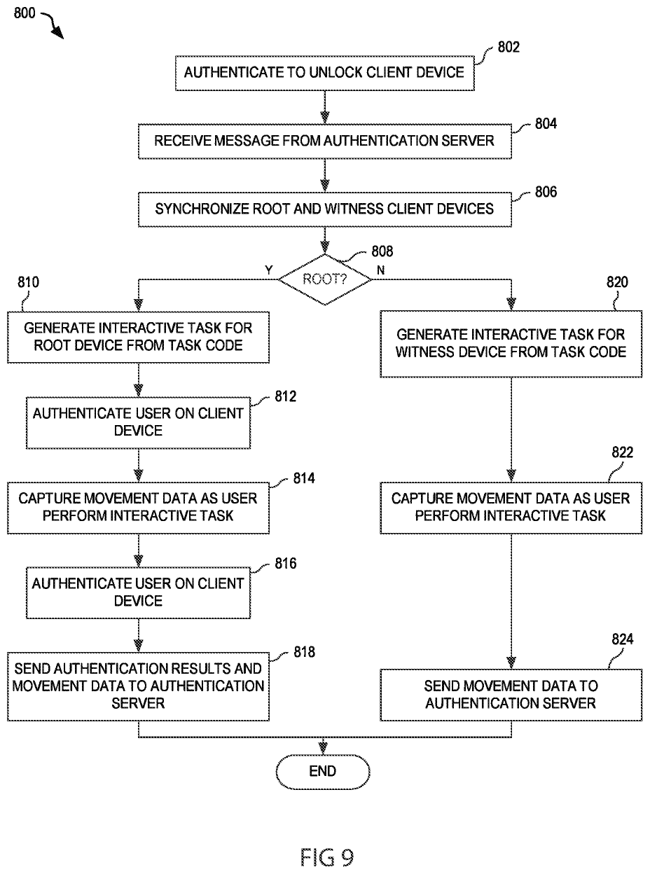

FIG. 9 is a flowchart illustrating one example method 800 of witnessing authentication of a user. Method 800 is, for example, implemented in application 60 to run on each of root device 200 and witness device 300. In block 802, method 800 authenticates to unlock the client device. In one example of block 802, application 60 authenticates user P to unlock root device 200. In another example of block 802, application 60 authenticates witness S to unlock witness device 300. In block 804, method 800 receives a message from an authentication server. In one example of block 804, application 60, running in root device 200, receives message 6501 from authentication server 100. In another example of block 804, application 60, running in witness device 300, receives message 6502 from authentication server 100. Messages 6501 and 6502 can indicate upon which of the root and witness client devices the application 60 is running.

In block 806, method 800 synchronizes root and witness client devices. In one example of block 806, device interface 614 of application 60 in root device 200 communicates with device interface 614 of application 60 in witness device 300 to synchronize operation of application 60 between both root device 200 and witness device 300. Although shown as block 806, this synchronization can occur more often throughout method 800 to maintain synchronization between root device 200 and witness device 300, particularly as user P performs interactive task 610.

In block 808 a decision is made. If, in block 808, method 800 determines that it is operating in the root client device, as indicated in the received message, method 800 continues with block 810; otherwise method 800 continues with block 820. Accordingly, block 810 through 818 are performed in root device 200 and block 820 through 824 are performed in witness device 300.

For Root Client Device: In block 810, method 800 generates an interactive task for the root client device from the task code. In one example of block 810, interactive task generator 611 is invoked to generate interactive task 610 from the perspective of root device 200, whereby the corresponding portion of virtual screen 2541 is generated. In block 812, method 800 authenticates the user. In one example of block 812, application 60 invokes root device 200 to perform an authentication (e.g., a facial, physiologic, and/or other authentication) of user P and stores the result (e.g., success or failure) in authentication results 603. In block 814, method 800 captures movement data as the user performs the interactive task. In one example of block 814, movement tracker 612 captures movement data 651 as user P performs interactive task 610. In block 816, method 800 authenticates the user on the client device. In one example of block 816, application 60 invokes root device 200 to perform an authentication (e.g., a facial, physiologic, and/or other authentication) of user P and stores the result (e.g., success or failure) in authentication results 603. In block 818, method 800 sends the authentication results and movement data to the authentication server. In one example of block 818, application 60 sends message 6503 containing authentication results 603 and movement data 651 to authentication server 100. Method 800 then terminates.

Method 800 is shown authenticating user P twice on root device 200, prior to starting the interactive task 610, and after completing interactive task 610. However, method 800 can authenticate user P at one, two, or more other times without departing from the scope hereof. For example, method 800 can authenticate user P at randomly selected times during interactive task 610.

For Witness Client Device: In block 820, method 800 generates the interactive task for the witness client device from the task code. In one example of block 820, interactive task generator 611 is invoked to generate interactive task 610 from the perspective of witness device 300, whereby the corresponding portion of virtual screen 2541 is generated. In block 822, method 800 captures movement data as the user performs the interactive task. In one example of block 822, movement tracker 612 captures movement data 652 as user P performs interactive task 610. In block 824, method 800 sends the authentication results and movement data to the authentication server. In one example of block 824, application 60 sends message 6504 containing movement data 652 to authentication server 100. Method 800 then terminates.

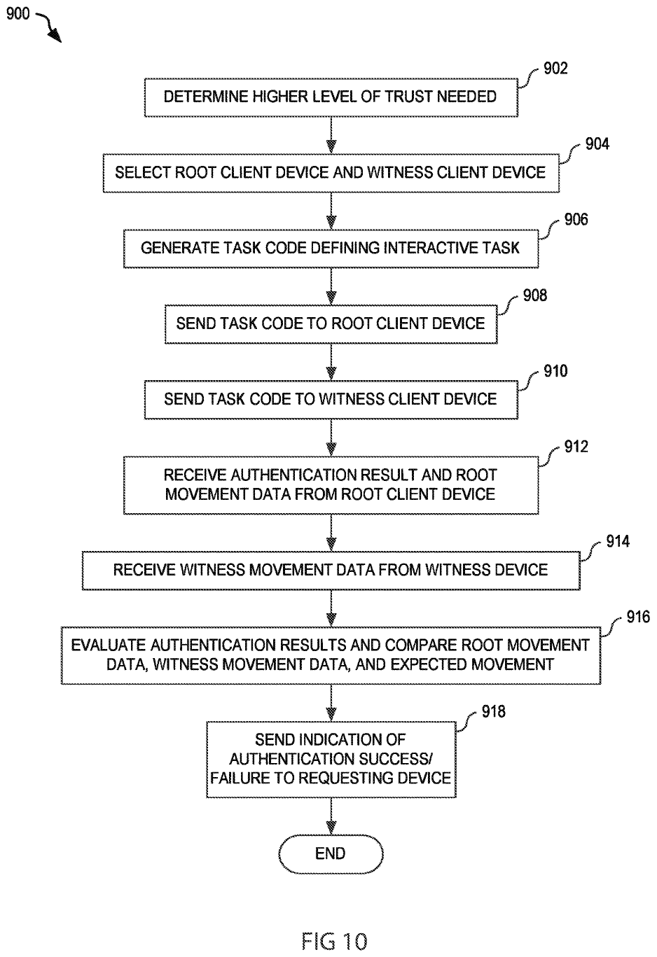

FIG. 10 is a flowchart illustrating one example authentication witness method 900 for witnessing authentication of a user to provide an improved level of trust. Method 900 is implemented in authentication software 600 of authentication server 100, for example. In block 902, method 900 determines that a higher level of trust is needed. In one example of block 902, authentication software 600 receives request 602 that indicates that a higher level of trust in authentication of user P is required. In block 904, method 900 selects a root client device and a witness client device. In one example of block 904, authentication software 600 determines root device 200 by retrieving user account 121 and user client device ID 1211 from database 120 based upon an identifier (e.g., username, account number, and the like) of user P, and determines witness device 300 from witness client device ID 1221 in witness client device list 122 of database 120 based upon one or more of previous association and/or current location of client devices 200 and/or 300.

In block 906, method 900 generates a task code (e.g., one, two, or more task codes) defining the interactive task (e.g., one, two, or more interactive tasks). In one example of block 906, authentication software 600 invokes code generator 604 to generate task code 81 and expected movement 6041 that defines movements expected to complete interactive task 610. In block 908, method 900 sends the task code to the root client device. In one example of block 908, authentication software 600 sends message 6501, including task code 81 and indicating that the recipient is the root client device, to root device 200. In block 910, method 900 sends the task code to the witness client device. In one example of block 910, authentication software 600 sends message 6502, including task code 81 and indicating that the recipient is the witness client device, to witness device 300.

In block 912, method 900 receives the authentication results and movement data from the root client device. In one example of block 912, authentication software 600 receives authentication results 603 and movement data 651 from root device 200. In block 914, method 900 receives movement data from the witness client device. In one example of block 912, authentication software 600 receives movement data 652 from witness device 300.

In block 916, method 900 evaluates authentication results and compares the “root movement data” (movement data recorded by the root client device), the “witness movement data” (movement data recorded by the witness client device), and the expected movement. In one example of block 916, authentication software 600 evaluates authentication results 603 to determine that authentication of user P in root device 200 was successful, then compares movement data 651 to movement data 652 to determine whether the authentication was successfully witnessed, and then determines whether interactive task 610 was performed correctly by comparing one or both of movement data 651 and movement data 652 to expected movement 6041.

In block 918, method 900 sends an indication of authentication success to the requesting device. In one example of block 918, authentication software 600 sends message 6031 to third-party server 400 indicating success or failure of witnessed authentication of user P (e.g., when message 6031 includes authentication result 603).

### Variations on Witnessed Authentication

The systems, devices, and methods, of the present inventive concepts can be of similar construction and arrangement as the similar components described in co-pending U.S. patent application Ser. No. 18/188,127, titled “Interactive Biometric Touch Scanner”, filed Mar. 22, 2023, and/or U.S. patent application Ser. No. 17/290,740, titled “Passwordless Authentication Systems and Methods”, filed Apr. 30, 2021.

In some embodiments, interactive task 610 may be simplified. In one example, user P is instructed to input a code, such as a code that is randomly generated by authentication server 100 and/or third-party server 400 and provided to user P (e.g., displayed on website 66), into root device 200 and witness device 300 as at least part of interactive task 610. Using the example of FIG. 5, website 66 can display a randomly generated code, such as “1776”, and ask that user P use head, eye, hand, and/or other body part movement to move cursor 6001 to enter that code. Accordingly, as user P controls cursor 6001 using head, eye, hand, and/or other movements captured by cursor controller 613, pausing for a predetermined amount of time (e.g., two seconds) with the cursor 6001 on and selecting a particular number, and thereby select numbers 6101 corresponding to the code. In some embodiments, as an alternative to pausing on the particular number, a “click” function (e.g., a function in which a displayed number, text, image, and/or other icon is activated and/or otherwise selected) is provided, such as a click that is generated when a particular motion (e.g., a finger snap, eye blink, and/or other body part motion) is performed by the user. Simultaneously, on each of root device 200 and witness device 300, movement tracker 612 captures the movements of user P as movement data 651 and 652, respectively. Thus, website 66 is also brought into the authentication process.

Alternatively, one of root device 200 and witness device 300 can display the code and the other device can be used to input the code using head, eye, hand, and/or other movement, whereby both root device 200 and witness device 300 capture the head, eye, hand, and/or other body part movements as movement data 651 and 652, respectively.

In some embodiments, system 10 comprises a device 200 and/or 300 that is configured as a sensing device (e.g., a biometric sensing device), such as a device that combines sensing with an actuator for two-way communication between a finger on a surface and the device, such as is described in co-pending U.S. patent application Ser. No. 18/188,127, titled “Interactive Biometric Touch Scanner”, filed Mar. 22, 2023. The sensing device can also function as an actuator. A finger can be authenticated based on an image of the finger (e.g., a fingerprint and/or other finger-based image) generated by the sensor and based on a response to energy delivered to the finger by the actuator. This two-way communication between the sensing device and the finger provides a more robust authentication of a person than fingerprint sensing alone. Device 200 and/or 300 configured as a biometric sensing device can also capture photoplethysmography (PPG) and/or other physiologic data from the finger being presented. The device 200 and/or 300 can capture one or more various forms of physiologic data from user P, such as physiologic data present currently that can be compared to previously generated and/or otherwise recorded physiologic information of user P in an authentication routine.

In some embodiments, cameras 2551 and 3551, projector/scanner 2552 and 3552, and/or another data capture device of root device 200 and/or witness device 300, respectively, can also capture physiologic data (e.g., PPG data) from the face or other body location of user P, and this physiologic data can be included in movement data 651 and 652, respectively, and evaluated by authentication software 600 as a further non-obvious determination of fraud, since the appropriate physiologic data (e.g., PPG data) from each of root device 200 and witness device 300 would not match if different people were used. Further, although not identifying of an individual person, the physiologic data (e.g., PPG data) can include expected physiologic characteristics (e.g., based on age or known health issues of user P) and thus an imposter can be detected when these characteristics are not matched correctly. In another example, while performing interactive task 610, user P may present a finger to one or both of root device 200 and witness device 300 and PPG and/or other physiologic data can be captured, such as by using a fingerprint scanner, optical sensor, pressure sensor, blood glucose sensor, motion sensor, and/or other sensor on either or both client devices.

In some embodiments, 3D data from the scanning (e.g., facial scanning) by projector/scanner 2552 and 3552 can be processed to select a subset of characteristics that may not be able to be used to assuredly identify user P, but that can be used to distinguish user P from other people based upon this subset of characteristics. For example, application 60 can process 3D data from projector/scanner 2552 and 3552 to determine certain characteristics of the face (e.g., only nose and upper lip), and application 60 can send these characteristics to authentication software 600 where they can be compared with previously captured characteristics of user P to confirm that user P is who they claim to be. While these recorded characteristics may not be able to assuredly identify user P, these characteristics can be used to detect when the person presenting as user P is an imposter.

In some embodiments, system 10 is configured to perform a “passwordless” authentication method that authenticates a user to access a remote computer, such as is described in co-pending U.S. patent application Ser. No. 17/290,740, titled “Passwordless Authentication Systems and Methods”, filed Apr. 30, 2021. For example, a mobile device can receive a flash pattern from a webpage and emit the flash pattern towards a body part of a user of the mobile device that is being authenticated (e.g., at least biometrically authenticated) at the mobile device. Concurrently with the authentication, a detected remission of the modulated optical signal by the body part can be recorded and used to verify that the authentication occurred during access to the website. Using a similar technique, website 66 can provide a randomly generated flash pattern that is projected onto the face of user P during witnessed authentication, such as while user P performs interactive task 610, and a corresponding flash pattern can be detected and extracted from images captured by either or both camera 2551 or 3551 and/or either or both projector/scanner 2552 or 3552. The extracted flash pattern can be void of identifying biometric and/or other sensitive information, and can be included with movement data 651 and/or 652 and sent to authentication server 100 where authentication software 600 can evaluate the flash pattern in the movement data against the flash pattern output on website 66 to verify that one or both of root device 200 and witness device 300 are located near where the website is being accessed. Such additional testing can further improve the level of trust in witnessed authentication of user P since spoofing of the authentication by a nefarious party is made more difficult by requiring the flashing pattern to match.

### Remote Witnessing of Authentication

To ensure a user that is accessing a resource (e.g., a website or a third party at a location remote from the user) is who they say they are, a witness can verify that the user is performing an authentication on a known client device at a particular time, and the witness can provide evidence that allows the entity being accessed (or another authenticating party) to verify that it is not receiving a previously recorded authentication of the user. When the witness is near to the user, the witness can provide evidence of the user being authenticated (e.g., using the witness client device to simultaneously capture evidence of the real-time authentication of the user by the root client device, as described hereinabove). However, when there is no witness nearby, directly witnessed authentication is not possible. Advantageously, the embodiments described herein provide a method for allowing a witness that is located remotely from the user to be authenticated to provide evidence that the user is authentic. As with the methods described hereinabove, the root client device can be configured to authenticate biometric and/or other characteristics (singly or collectively “biometric characteristics” herein) of the user to the root client device.

By providing evidence of the user performing the authentication live (e.g., not a recording), the witness provides the resource, or authenticating party, with an increased level of trust that the authentication of the user is valid, since spoofing of the authentication by a nefarious party is made more difficult by requiring the remote witness. Particularly, where the witness is selected at random from a plurality of available witnesses, such as by the entity (e.g., a financial institution and/or a government security agency) requiring the authentication and/or a third party that provides such individuals for witnessing, a nefarious party is unable to predict who will witness the authentication and is also unable to use a false witness.

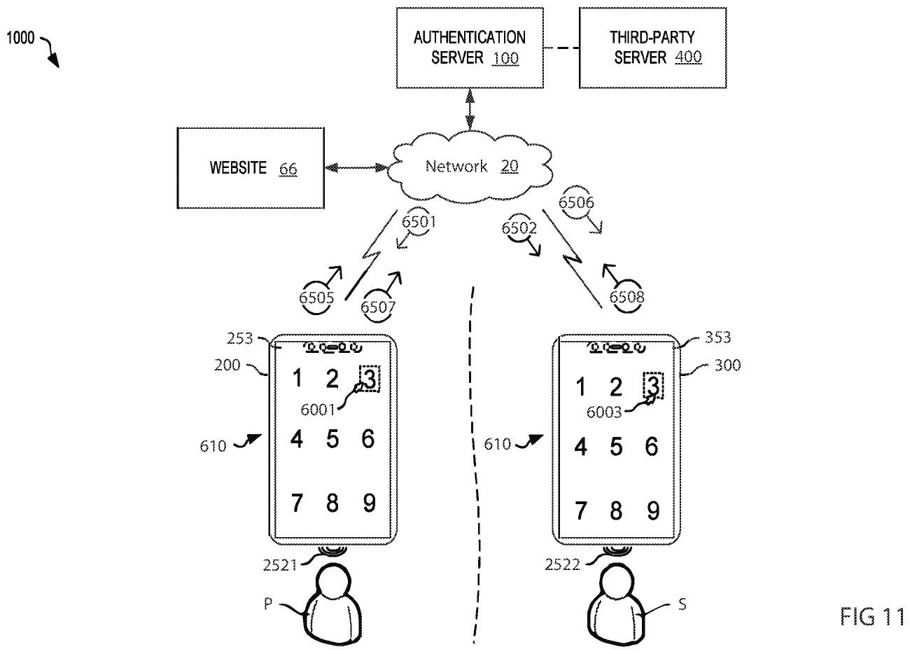

FIG. 11 is a functional block diagram showing one example authentication witness scenario 1000 that improves a level of trust when authenticating a user P to an authentication server 100 (e.g., to access a protected resource such as a financial account, a transaction, a transfer, a document, and the like) via a website 66. Unlike the scenarios, examples, and solutions described hereinabove, root device 200 and witness device 300 are located remotely from each other and do not directly communicate using short range wireless protocols, and witness device 300 cannot simultaneously capture facial, head, eye, hand, and/or other body part movement and/or physiologic data of user P during authentication of user P by root device 200. Accordingly, witness S is asked to witness the authentication of user P on root device 200 remotely. User P is asked to perform an interactive task 610 presented on a display 253 of root device 200, while being authenticated by root device 200. Witness S is asked to witness and respond to user P performing the interactive task 610, by following the actions (e.g., motions) of user P that are displayed on display 353 of witness device 300, and optionally, while witness S is authenticated by witness device 300. Functionality of authentication server 100 and devices 200 and 300 are similar to functionality described hereinabove with reference to FIGS. 2 through 10, but it has been modified to allow remote witnessing of the authentication as described below.

To initiate the witnessed authentication, authentication software 600 running in authentication server 100 sends messages 6501 and 6502 (e.g., notifications) to root device 200 and witness device 300, respectively, that causes each client device to start application 60 when it is not already running. Message 6501 instructs application 60 running on root device 200 that it is to behave as the root client device, and message 6502 instructs application 60 running on witness device 300 that it is the witness client device. In some embodiments, both root device 200 and witness device 300 determine (e.g., automatically determine) that short-range direct communication with each other is not possible, and that root device 200 and witness device 300 are remotely located from each other.

When remotely located, application 60, running on each respective root device 200 and witness device 300, selects a corresponding remote interactive task, such as interactive task 610. Messages 6501 and 6502 can also include task code 81 that is randomly generated by authentication server 100 and used to determine which of a plurality of different and varied remote interactive tasks (e.g., interactive task 610) is to be performed by user P.

In the example of FIG. 11, interactive task 610 includes a grid of numbers presented on display 253 of root device 200 and on display 353 of witness device 300. Unlike the examples of FIGS. 2, 3A, 3B, 5, 6, 7, 9, and 10, interactive task 610 does not use a virtual screen that is shared between both root device 200 and witness device 300; instead, interactive task 610 has substantially the same content on both displays 253 and 353 of corresponding root device 200 and witness device 300. In one embodiment, witness S can generate instructions (e.g., audible or visual instructions that are captured by witness device 300 and sent to root device 200 via authentication server 100) for user P to follow to complete interactive task 610. In some embodiments, authentication server 100 generates instructions for user P to follow to complete interactive task 610.

Application 60 running in root device 200 outputs audio 2521 instructing user P to complete interactive task 610. For example, audio 2521 can verbally, and/or via a provided display can visually, instruct user P to “move the cursor to number three, then move the cursor to number seven.” Application 60 can track head, eye, hand, and/or other movement of user P to control movement of cursor 6001 to select the numbers on display 253 as instructed.

Application 60 running on root device 200 captures interactive task 610 related updates to display 253 caused by actions (e.g., cursor movements and/or selection of numbers) of user P and sends the updates to authentication server 100, illustratively shown as message 6505. Authentication server 100 forwards the updates to witness device 300, shown as message 6506, and application 60 running on witness deice 300 shows the updates on display 353 of witness device 300. Although shown as single messages 6505 and 6506, these messages represent frequent flow of data corresponding to real-time task updates (e.g., actions) by user P. Thus, witness device 300 shows the actions (e.g., motions) of user P performing interactive task 610 substantially in real-time. Application 60, running on witness device 300 can instruct witness S to also interact with interactive task 610 on witness device 300 by responding to the actions made by user P as shown on display 353. In one example, witness S is instructed via output from witness device 300 (e.g., via audio 2522 from device 300), to make actions (e.g., motions) similar to user P, such as to use head, eye, hand, and/or other movements to control a cursor 6003 to select the numbers that are selected by user P. In another example, witness S is instructed via output from witness device 300 (e.g., via audio 2521), to tap (e.g., using a finger) on a highlighted number on display 353, where the highlighted number corresponds to selections made by user P. Accordingly, witness S confirms, or replicates actions made by user P.

In one example of operation, user P is instructed (e.g., via audio 2521) to “move the cursor to number three,” and witness S is instructed (e.g., via audio 2522) to “move the cursor to select the highlighted numbers.” As user P follows this instruction, application 60 sends display updates (e.g., as message 6505 including cursor movements and/or number selection) to authentication server 100, which in turn sends a corresponding display update (e.g., as message 6506) to witness device 300 that causes application 60 to update display 353 of witness device 300 to show the cursor movement and number selection made by user P. In response to seeing the cursor move to the number three, witness S makes actions (e.g., as instructed by application 60) to control a local cursor 6003 to move to and select the number three. Application 60 running on witness device 300 captures movement of witness S, and the selection of the number three, and sends this information in message 6508 to authentication server 100.

As described in detail hereinabove, root device 200 captures facial movements as user P performs interactive task 610. Similarly, witness device 300 captures movement data 652 of witness S responding to actions taken by user P. At one or more times (e.g., at the beginning, midway through, and at the end) during capture of movement data 651 and 652, while user P responds to interactive task 610 and witness S responds to actions taken by user P, application 60 can cause root device 200 to authenticate user P using facial recognition and application 60 can cause witness device 300 to authenticate witness S using facial recognition.

When interactive task 610 is complete, application 60 running on root device 200 sends a message 6507 to authentication server 100 containing results of the one or more authentications performed by root device 200 during interactive task 610, actions (e.g., selected numbers) of user P, and/or movement data 651. Application 60 running on witness device 300 sends a message 6508 to authentication server 100 containing results of the one or more authentications performed by witness device 300 during interactive task 610, actions (e.g., selected numbers) of witness S, and movement data 652 of witness S. Authentication software 600 processes messages 6507 and 6508 to determine authentication results 603 that indicate whether access to website 66 (or the protected resource, transaction, transfer, document, action of high importance, and the like) is granted for user P. In this processing, authentication software 600 evaluates the results of authenticating user P during interactive task 610, received in message 6507, to determine if a first level of trust is confirmed. Authentication software 600 also evaluates the results of authenticating witness S during interactive task 610 received in message 6508 and determines if a second level of trust is confirmed. If either or both the first and second levels of trust are not confirmed, authentication software 600 terminates (e.g., denies) authentication.

Authentication software 600 can then compare results (e.g., number selections) from the completed interactive task 610 by user P, and the results (e.g., number selections) from the interactive task 610 performed by witness S. Matching results indicate that witness S successfully viewed and replicated actions (e.g., motions) made by user P. When the results do not match, authentication software 600 terminates with unsuccessful authentication of user P.

Next, authentication software 600 can compare movement data 651, received in message 6507, to movement data 652, received in message 6508, to determine whether witness S made similar movements to those of user P to determine a second level of trust. For example, where witness S makes similar movements to those made by user P, each root device 200 and witness device 300 can capture substantially the same movements as user P follows interactive task 610 and witness S follows actions, seen on display 353, of user P. Accordingly, movement data 652 (of witness S) should include movements very similar to movements defined by movement data 651 (of user P). Slight timing variances between actions in movement data 651 and in movement data 652 are expected and can be allowed for, however. Authentication software 600 can also compare detected actions (e.g., facial movement, hand movement, and/or other recorded movement) to expected movement 6041 corresponding to task code 81. For example, the sequence and timing of movements detected and stored within each of movement data 651 and 652 should be similar to expected movement 6041 for interactive task 610 corresponding to the generated task code 81. Thus, a replay attack where previously captured messages 6505 and 6506 are resent to authentication server 100 will not match expected movements since task code 81 is regenerated for each two-device authentication attempt and thus the expected movements are not the same for subsequent authentications. Accordingly, authentication software 600 is not fooled by replay attacks, making subterfuge significantly more difficult.

In some embodiments, interactive task 610 can involve witness S choosing two numbers in a range of numbers (e.g., between one and nine) at random, and asking user P to select the chosen numbers (e.g., 3 and 7) on display 253 using head/face/eye/hand and/or other movement-based cursor control. When witness S confirms that user P used cursor control 613 to select the number chosen by witness S, authentication server 100 can analyze movement data received from root device 200 to verify that the user's movements correspond to the position of numbers chosen by witness S and sent to authentication server 100. Using the example of selecting the three and then the seven, authentication server 100 determines that the user's movement corresponds to the chosen numbers when movement data indicates that a body part (e.g., the head) of user P first moves up and right (e.g., when selecting the number three) and then down and left (e.g., when selecting the number seven). When such movement is not found in the movement data, authentication server 100 can determine the authentication as fraudulent. Similarly, where witness S follows the cursor movement on display 353, authentication server 100 can verify that movement data from witness device 300 also includes similar movements that were captured contemporaneously.

Authentication software 600 can send a message 6031 to third-party server 400 indicating a result (e.g., success or failure) of witnessed authentication of user P, where success indicates that user P was successfully authenticated on root device 200, the captured movement data 651 matches movement data 652 indicating that witness device 300 was present to witness the authentication, and that one or both of movement data 651 and 652 matches expected movement (see for example expected movement 6041 in FIG. 8) corresponding to interactive task 610 to indicate that user P performed the interactive task 610. Success of all evaluations by authentication software 600 indicates a higher level of trust that user P is who they claim to be. As with local authentication (e.g., where root device 200 and witness device 300 are at the same location), witness S can be known or unknown to any one or more of user P, authentication server 100, and/or third-party server 400. One advantage over a verbal indication, where a third party verbally indicates that user P is who they say they are, is that, for the scenario shown in FIG. 11, witness S is authenticated to witness device 300 during witnessing of the authentication, and thus the witness cannot be replaced by a nefarious party attempting to impersonate the witness without detection. Particularly, root device 200 can confirm a physiologic and/or other biometric characteristic of the user to identify the user P, and in the same period, both user P and witness S interact (e.g., using interactive task 610) and (a) head/facial/eye/hand/other body part motion captured by both root device 200 and witness device 300 during the interaction and is sent to authentication server 100 (or third-party server 400) and/or (b) actions (e.g., cursor movements and/or number selections, and the like) made by both user P and witness S, can be sent from the root client device and/or the witness client device, respectively, to the authenticating server 100. The authentication server 100 can verify that the movements and/or other actions match and correspond to the provided interactive task 610. For example, as user P makes head, eye, hand, and/or other body part movements to move a cursor over one of a plurality of images (e.g., images comprising pictures, icons, text, numbers, and/or the like) on a screen of root device 200, the cursor movement is sent to witness device 300 via authentication server 100, and witness S uses head, eye, hand, and/or other body part movements to control a local cursor to select the same image. In another example, as user P makes head, eye, hand, and/or other body part movements to move a cursor over one of a plurality of images on a screen of root device 200 to select one or more of the images, witness device 300 is controlled to show one or both cursor movement and image selection(s) made by user P. Other types of interactive game, challenge, and/or other activity can be used to allow both parties to engage at the same time.

Where user P and witness S are at the same location, but not known to one another, handing over of witness device 300 to user P may not be desired. Further, where interactive task 610 requires user P to control a cursor (e.g., cursor 6001), such as to select a pre-known image (e.g., an image comprising a number, text, picture, icon, and/or the like) or select a code using displayed digits, it may be desirable to hide the selections made by user P from witness S. Accordingly, in some embodiments when user P and witness S are collocated, but witness S is a stranger to user P, user P may not wish for information and/or actions made during the authentication process to be overseen by witness S. Accordingly, rather than sharing the same virtual screen for display on both root device 200 and witness device 300, a separate, non-virtual screen can be generated for display on witness device 300.

Preferably, even though unknown to user P, witness S is known in another context, such as an Uber driver, a FedEx driver, and/or an employee of another well-known organization, where witness S is thus known and tracked by another reliable server. Accordingly, through tracking by another server (e.g., a server of Uber or FedEx), witness S provides increased trust over another witness that is not known and is not tracked by another server. As noted hereinabove, any company/organization that registers and tracks a smartphone and/or computer of a user on the associated company's database would allow that user to fulfill this notary type authentication service. Similarly, hotel desk employees, pharmacy employees, bank and/or other such business employees may fulfill this notary type authentication service. Since the user/employee is registered with the company/organization, the user/employee is traceable by authentication server 100 if needed. This independent tracking of witness S provides additional trust in the authentication of user P provided by system 10.

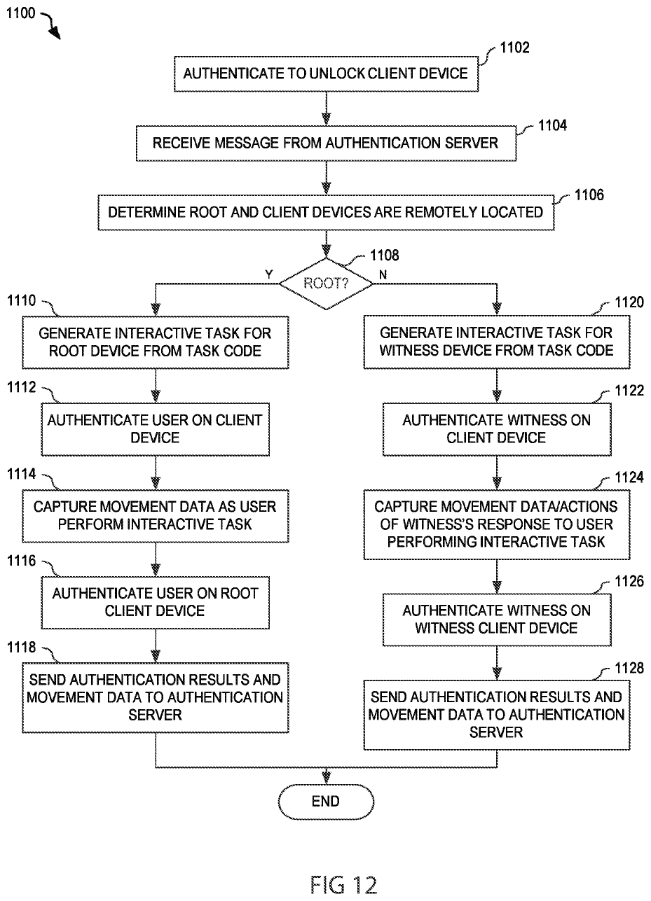

FIG. 12 is a flowchart illustrating one example method 1100 for remotely witnessing authentication of a user of a root client device. Method 1100 is implemented within application 60, for example.

In block 1102, method 1100 authenticates to unlock the client device. In one example of block 1102, application 60 authenticates user P to unlock root device 200. In another example of block 1102, application 60 authenticates witness S to unlock witness device 300. In block 1104, method 1100 receives a message from an authentication server. In one example of block 1104, application 60, running in root device 200, receives message 6501 from authentication server 100. In another example of block 1104, application 60, running in witness device 300, receives message 6502 from authentication server 100. Messages 6501 and 6502 can indicate which of the root and witness client devices the application 60 is running on.

In block 1106, method 1100 determines that the root and client devices are remotely located. In one example of block 1106, application 60 running on root device 200 fails to connect with wireless witness device 300 using a short-range wireless protocol (e.g., Bluetooth) and therefore determines that wireless witness device 300 is not at (or at least not near) the location of root device 200. In block 1108, a decision is made. If, in block 1108, method 1100 determines that method 1100 should continue with blocks 1110 through 1118 executed on the root client device, and method 1100 continues with block 1110; otherwise, method 1100 continues with blocks 1120 through 1128 on the witness client device, and method 1100 continues with block 1120.

In block 1110, method 1100 generates an interactive task for the root client device from the task code and outputs instructions (e.g., audio instructions). In one example of block 1110, application 60 running on root device 200 generates interactive task 610 to display a grid of numbers on display 253 of root device 200 and outputs information (e.g., audio 2521) from root device 200 instructing user P to use head, eye, hand, and/or other body part movement to control cursor 6001 to select a particular number or other icon (e.g., number three). In block 1112, method 1100 authenticates the user on the root client device. In one example of block 1112, application 60 invokes root device 200 to authenticate user P.

In block 1114, method 1100 captures movement data as user performs the interactive task. In one example of block 1114, as user P performs interactive task 610 on root device 200, application 60 captures movement data 651. In block 1116, method 1100 authenticates the user on the root client device. In one example of block 1116, application 60 invokes root device 200 to authenticate user P. In block 1118, method 1100 sends authentication results and the movement data to the authentication server. In one example of block 1118, application 60 sends message 6503 containing authentication results 603 and movement data 651 to authentication server 100. Method 1100 then terminates.

In block 1120, method 1100 generates an interactives task for the witness client device from the task code and outputs instructions to the witness from the witness client device. In one example of block 1120, application 60 generates interactive task 610 to display the same grid of numbers on display 353 of witness device 300 and outputs information (e.g., audio 2521) from witness device 300 instructing witness S to use head, eye, hand, and/or other body part movement to control cursor 6003 to select numbers highlighted on display 353. In block 1122, method 1100 authenticates the witness on the witness client device. In one example of block 1122, application 60 invokes witness device 300 to authenticate witness S and updates authentication results 6032.

In block 1124, method 1100 captures movement data/actions of witness's response to the user performing the interactive task. In one example of block 1124, application 60 captures movement data 652 as witness S responds to updates of display 353 as user P performs interactive task 610. In block 1126, method 1100 authenticates the witness on the witness client device. In one example of block 1126, application 60 invokes witness device 300 to authenticate witness S and updates authentication results 6032. In block 1128, method 1100 sends the authentication results and the movement data to the authentication server. In one example of block 1128, application 60 sends message 6504 containing authentication results 6032 and movement data 652 to authentication server 100. Method 1100 then terminates.

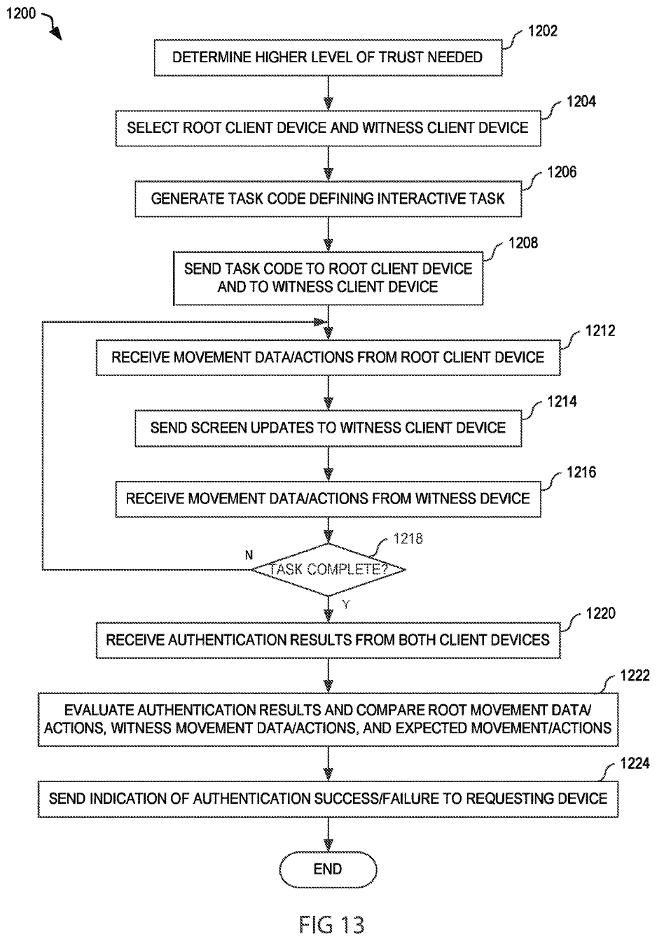

FIG. 13 is a flowchart illustrating one example remote authentication witness method 1200 for witnessing authentication of a user to provide an improved level of trust. Method 1200 is similar to method 900 of FIG. 10 but adapted to allow the witness to be remote from the user being authenticated. Method 1200 is implemented in authentication software 600 of authentication server 100, for example.

In block 1202, method 1200 determines that a higher level of trust is needed. In one example of block 1202, authentication software 600 receives request 602 that indicates that a higher level of trust in authentication of user P is required. In block 1204, method 1200 selects a root client device and a witness client device. In one example of block 1204, authentication software 600 determines root device 200 by retrieving user account 121 and user client device ID 1211 from database 120 based upon an identifier (e.g., username, account number, and the like) of user P, and authentication software 600 also determines witness device 300 from witness client device ID 1221 in witness client device list 122 of database 120 based upon one or more of previous association and/or current location of devices 200 and/or 300.

In block 1206, method 1200 generates the task code defining the interactive task. In one example of block 1206, authentication software 600 invokes code generator 604 to generate task code 81 and expected movement 6041 that defines movements expected to complete interactive task 610. In block 1208, method 1200 sends the task code 81 to the root client device. In one example of block 1208, authentication software 600 sends message 6501, including task code 81 and indicating that the recipient is the root client device, to root device 200. Also in block 1208, method 1200 sends the task code 81 to the witness client device. In one example of block 1208, authentication software 600 sends message 6502, including task code 81 and indicating that the recipient is the witness client device, to witness device 300.

In block 1212, method 1200 receives movement data and/or selection actions from the root device 200. In one example of block 1212, authentication software 600 receives movement data 651 and/or selection actions from root device 200. In block 1214, method 1200 sends screen updates to witness device 300. In one example of block 1214, authentication software 600 sends updates to display 353 corresponding to movement data 651 and/or selected actions received from root device 200. In block 1216, method 1200 receives movement data and/or selection actions from the witness client device. In one example of block 1216, authentication software 600 receives movement data 652 and/or selection actions from witness device 300.

In block 1218 a decision is made. If, in block 1218, method 1200 determines that the interactive task has been completed, method 1200 continues with block 1220; otherwise, method 1200 continues with block 1212. Blocks 1212 through 1218 repeat until user P and witness S finish interactive task 610.

In block 1220, method 1200 receives authentication results from both client devices 200 and 300. In one example of block 1220, authentication software 600 receives authentication results 603 from root device 200 and receives authentication results 6032 from witness device 300. In block 1222, method 1200 evaluates the authentication result and compares the root movement data and/or selection actions, the witness movement data and/or selection actions, and the expected movements and/or selection actions. In one example of block 1222, authentication software 600 evaluates authentication results 603 to determine that authentication of user P in root device 200 was successful and evaluates authentication results 6032 to determine that authentication of witness S in witness device 300 was successful, then compares movement data 651 and/or selection actions to movement data 652 and/or selection actions to determine whether the authentication was successfully witnessed, and then determines whether interactive task 610 was performed correctly by comparing one or both of movement data 651 and/or selection actions and movement data 652 and/or selection actions to expected movement 6041 and/or expected selection actions.

In block 1224, method 1200 sends an indication of authentication success to the requesting device. In one example of block 1224, authentication software 600 sends message 6031 to third-party server 400 indicating success or failure of witnessed authentication of user P.

Method 1200 confirms that witness S experienced user P performing interactive task 610 in real-time, and since user P was authenticated by root device 200 as interactive task 610 was being performed, witness S confirms that the authentication occurred in real-time by user P. Since witness S is following the actions of user P (e.g., repeating the witnessed actions) without receiving direct instructions from the authentication server 100, when movement data 652 (e.g., movements of witness S) matches expected movement 6041, authentication server 100 increases confidence that user P was authenticated by root device 200.

Although the user interactively controls cursor 6001 to select numbers on a screen, interactive task 610 can also be an interactive game, a word game, and/or other such task where the user P provides interaction in real-time that can be witnessed remotely.

In some embodiments, witness S may be known to user P (e.g., identified in witness ID list 122 in association with user P). In other embodiments, witness S may not be known to user P but may be selected by authentication server 100.

In the embodiments described hereinabove, the user P performs the task that is replicated by witness S. However, the roles can be reversed, whereby witness S performs interactive task 610, and movement data 651 of user P is captured in response to that performance.

### Virtual World

In some embodiments, interactive task 610 can represent a virtual world where user P and witness S may “virtually meet” and where actions of user P can be witnessed by witness S. For example, both of user P and witness S can each control their own avatars (e.g., a root avatar and a witness avatar) in the virtual world and may thereby meet virtually at a selected (e.g., by either of user P or witness S) location in the virtual world. In some embodiments, head, facial, eye, and/or other body part movements of user P are captured by root device 200 and control corresponding head, facial, eye, and/or other body part movements of the root avatar in the virtual world. Similarly, head, facial, eye, and/or other body part movements of witness S can be captured by witness device 300 and control corresponding head, facial, eye, and/or other body part movements of the witness avatar. Accordingly, when at the same location in the virtual world, user P and witness S may view each other's movements.

In some embodiments, the user P and the witness S can be instructed to meet at a location within the virtual world that is selected based on head, eye, hand, and/or other body part movements of user P, witness S, or both of these.

In some embodiments, one or more users of system 10 (e.g., user P and/or witness S) can interact with a virtual world, for example in an augmented reality and/or a virtual reality setting, such as a setting provided by authentication software 65 described herein. Authentication software 65 can present an interactive task 610 to the user including a set of images, of which a subset (e.g., one of twenty images) are familiar to the user, and/or have a special meaning to the user. For example, user P can be presented with a virtual room with a set of images displayed on the walls of the virtual room. The user can review the images and approach (or otherwise indicate the selection of) the appropriate image, the selection of which authentication software 600 can analyze to authenticate user P. In some embodiments, when an image is selected, instructions can be given to user P, for example to proceed to a second virtual room. In some embodiments, false instructions can be associated with incorrect images, such that an imposter would be instructed to perform incorrect subsequent actions. In some embodiments, a description of the image can be presented along with instructions, for example a description which may or may not appropriately describe the picture to user P, such that user P knows to ignore the instructions (or perform the opposite) if the description does not accurately describe the picture. Once user P continues to the subsequent virtual room, the identity of user P can be confirmed by authentication server 100, and/or a second portion of interactive task 610 can be presented, such as a second set of images from which the user can select an appropriate image.

In some embodiments, authentication software 600 tracks various aspects of user P's interaction with the virtual world, for example eye tracking, physical movements, and other aspects of the user's interaction as described herein. In some embodiments, authentication software 600 is configured to verify the identity of user P based on the results of interactive task 610 and the manner in which user P interacts with the virtual world. In some embodiments, proper completion of interactive task 610 is not sufficient to authenticate user P if the user's interaction with the virtual world is unusual (e.g., when authentication server 100 has information related to user P's pervious interactions with virtual environments).

In some embodiments, interactive task 610 comprises a virtual game or other virtual interaction in which user P performs an activity while authentication server 100 monitors user P's interaction with the environment (e.g., user P's performance in the game) to gather authentication information. In some embodiments, user P and user S perform an interactive task together, for example, where the actions of the users are synchronized (e.g., where each user tracks a bouncing ball), and/or where the actions of the users are complementary (e.g., when the users play a game of pong).

### Anonymous Witness

A user (e.g., user P and/or secondary users S) is often part of an online community, where members of the community can confidently recognize one another, and form a group that is able to defend itself strongly against fraud and scams of nefarious parties, where any intruder or person impersonating another member is quickly discovered. Such a community is a good source of witnesses (e.g., witnesses S) that can be utilized for witnessed authentication. For example, such a community provides a better and safer way to recognize and confirm that the user is who they claim to be, and to detect someone impersonating the user, than could be performed by an individual such as a bank person (e.g., a bank or similar person that is not in regular contact with the user), since the bank person has insufficient contact with the user to recognize the voice of user. The members of the community can collectively validate each other through frequent contact. Advantageously, the embodiments herein can use such communities. However, members of such a community may not wish to be identified to the authentication server or third party.

In certain situations, it is preferred that a witness, such as witness S, and their witness client device (e.g., witness device 300), are not known to either authentication server 100 or to third-party server 400, but witness S and their witness device 300 are preferably known to, and trusted by, a user P being authenticated. When witness device 300 (and thus the witness S) is anonymous to the authentication server, a vulnerability of the witness's identity (or the identity of their client device) being learned from traffic intercepted between authentication server 100 and the root device 200 (of the user being authenticated) is eliminated. Thus, a nefarious party cannot learn of, compromise, or replicate the witness S or witness device 300 since it is not identified to authentication server 100 and is not traceable at the time of authentication. The nefarious party cannot replicate or impersonate an unknown entity. However, authentication server 100 needs to determine that the anonymous witness is authorized, by the user, to witness authentication of the user. That is, authentication server 100 needs to be able to verify that the anonymous witness S is one of the people trusted by user P to provide the witnessed authentication. In some embodiments, for a user P to register an anonymous witness S with authentication server 100, authentication server 100 can provide user P with an authentication code (e.g., via secure transfer described herein and/or via local transfer, such as transfer via Bluetooth). User P can provide anonymous witness S with the authentication code (e.g., via any transfer means described herein), such that anonymous witness S can provide the code to authentication server 100 to register as a witness. Anonymous witness S can register with authentication server 100 anonymously, such that authentication server 100 only knows witness S as an entity that provided the authentication code originally provided to user P, indicating that witness S is an entity known to and trusted by user P.

In some embodiments, a request to authenticate a user P is sent to a witness, such as a user of system 10 that has been registered by user P as an authenticating witness. The witness (e.g., user S) can comprise a remote witness (e.g., a user not physical present with user P), such as a user who is registered with authentication server 100 as an anonymous witness of the present inventive concepts. Authentication server 100 can be configured to request an authentication via a digital request sent from authentication server 100 to user S (e.g., the anonymous witness). In some embodiments, the digital request can be transmitted (e.g., via network 20) from authentication server 100 to witness device 300, via application 60. Alternatively, to keep the identity of the witness and/or any details of the authentication process hidden from any nefarious parties (e.g., nefarious parties who may attempt to monitor communication from authentication server 100 to one or more users for illicit purposes), a request may be sent from third-party 3P, such as an email request sent to the witness. The email request can comprise a link to open application 60 to initiate an authentication. Alternatively the request can contain a predetermined message (e.g., a nonsensical message to an observer) which indicates to the witness that their services have been requested. Emails or other communications from third-party 3P (e.g., from third party server 400 via network 20) may be more difficult for a nefarious party to intercept due to the volume of outbound communications from third-party server 400. In some embodiments, communications from authentication server 100 and/or third-party server 400 are sent to the witness (e.g., an anonymous witness) via an anonymous communication network, such as the onion router.

In some embodiments, for example when one or more users wish to remain anonymous, for example when interacting in a virtual world, one or more characteristics of the anonymous user can be disguised in the virtual world. For example, the user's voice can be distorted, and/or the likeness of the user can be altered (e.g., if video or other images of the user are presented to other participants in the virtual world). In some embodiments, a first set of users that are present in the virtual world are presented with the identifying characteristics of the other users (e.g., user P and anonymous witness S can see each other in the virtual world), but a second set of users, for example a user from third-party 3P that is present in the virtual world with user P and anonymous witness S, is not presented with the identifying characteristics of at least one of the users of the first set. For example, users of the second set of users may only be presented with one or more generic avatars, and/or altered voices (or transcribed text without voice).

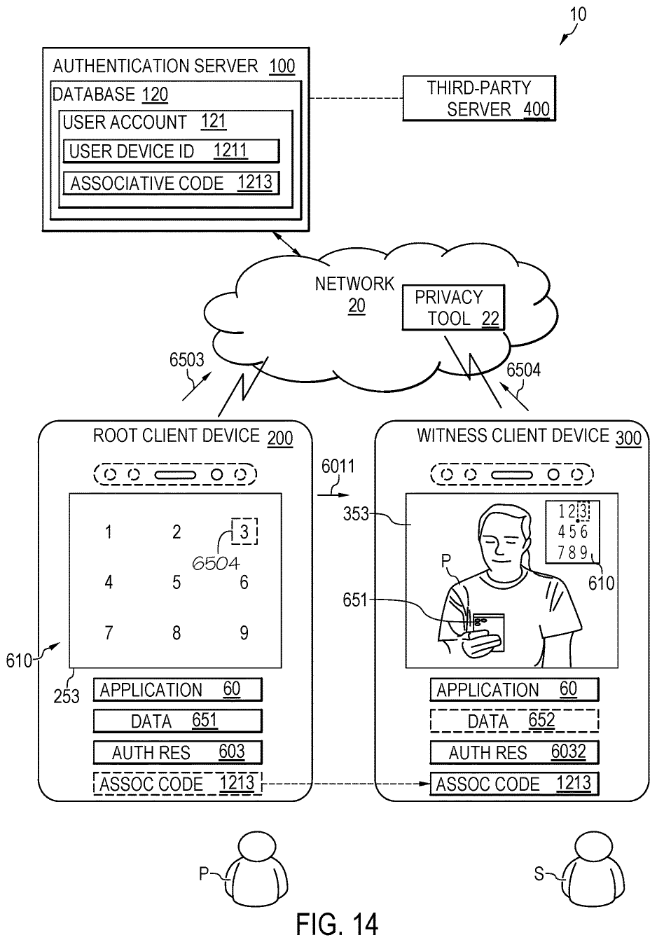

FIG. 14 is a functional block diagram showing one example system for anonymous witnessed authentication. System 10 includes network 20 which can be used for communication between two or more components of system 10. Network 20 can be configured and used in a similar way to network 20 described in reference to FIG. 1 and otherwise herein. System 10 includes an authentication server 100 that accepts evidence via message 6504, from a witness S to a user P performing authentication on a root device 200 (e.g., similar to root device 200 described herein). Witness S is known to user P, but witness S and a witness device 300 (e.g., similar to witness device 300 described herein) used by witness S is anonymous to authentication server 100 (and third-party server 400). Further, witness device 300 is also untraceable by authentication server 100 (and third-party server 400). Witness S may be local to user P (e.g., at the same location) or may be remote from user P (e.g., performing a remote witnessed authentication as described hereinabove). However, in either case, witness S remains anonymous to authentication server 100 and third-party server 400.

In this example, application 60 is downloaded to (e.g., via network 20), and runs on, each of root device 200 of user P and witness device 300 of witness S. Authentication server 100 includes a database 120 that stores a user account 121 corresponding to user P, which can store a user client device ID 1211 that uniquely identifies root device 200 and an associative code 1213 that uniquely identifies user account 121. Authentication server 100 can provide a service to a third-party server 400 that protects a valuable asset (e.g., bank account, stocks, real-estate, and/or another valuable asset) of user P by improving trust in authentication when user P accesses third-party server 400. Alternatively or additionally, a user performing any action of high importance (e.g., as described herein) can be authenticated. For example, when user P requests access to third-party server 400 to make a high-value transaction and/or make another action of high importance, third-party server 400 can invoke authentication server 100 to perform a user authentication routine that further validates the authentication of user P and thereby gain trust that user P is who they claim to be. However, to develop additional trust in user P, authentication server 100 can require proof that the witness S witnessing the authentication of user P is the trusted witness that user P selected, and that neither user P nor witness S are imposters. In one scenario, a nefarious party may obtain and compromise root device 200 to impersonate user P, and may then attempt to use an equally nefarious accomplice to impersonate witness S. System 10 can be configured to detect this scenario, such as to prevent an inaccurate authentication via these types of fraud.

In some embodiments, to prevent fraudulent use of root device 200 when compromised, authentication server 100 ensures that witness device 300 belongs to an authorized witness of user P by verifying a code (e.g., a unique token or other unique coding element) previously configured with witness device 300. For example, prior to witnessed authentication (e.g., days, or weeks before), user P interacts with application 60 to request associative code 1213 from authentication server 100 and securely passes associative code 1213 to witness device 300 of witness S. For example, when asking witness S to act as an authentication witness, user P may interact with application 60 to receive associative code 1213 from authentication server 100 and transfer associative code 1213 to witness device 300 using a short range encrypted wireless protocol (e.g., Bluetooth). For security reasons, application 60 running on root device 200 only stores associative code 1213 temporarily on root device 200, deleting it from root device 200 once it is transferred to witness device 300. Accordingly, associative code 1213 is not retrievable from root device 200, should root device 200 become compromised. Thereafter, witness device 300 sends associative code 1213 to authentication server 100 as confirmation of its authority to witness authentication of user P. Authentication server 100 cannot identify witness S or witness device 300, since it did not deliver associative code 1213 directly, and user P was able to deliver associative code 1213 independently of authentication server 100.

In one example of operation, when user P attempts a high value transaction with third-party server 400, third-party server 400 invokes authentication server 100, which communicates with application 60 running on root device 200 to request witnessed authentication. From root device 200, application 60 sends a message 6011 (e.g., a text message, an email, and the like) to witness device 300 requesting that witness S witnesses authentication of user P (e.g., an authentication sent via authentication results 6032). Alternatively, user P may call (e.g., using a phone) witness S to request witnessed authentication. Witness S runs application 60 on witness device 300 to initiate witnessed authentication.

In some embodiments, application 60 establishes a video-based phone call and/or a video-based web meeting between root device 200 and witness device 300 such that witness S at least sees user P operating root device 200. In other embodiments, application 60 can invoke other software to establish the video-based interaction between root device 200 and witness device 300. On root device 200, application 60 then generates and displays an interactive task 610 on display 253 of root device 200, and application 60 can send data to replicate interactive task 610 on display 353 of witness device 300. Accordingly, witness S may see the face and/or actions (e.g., head, face, hand, and/or other body motions) of user P as user P completes interactive task 610. Interactive task 610 can be similar to interactive task 610 of FIG. 11, but task 610 can be similar to any one or more of the interactive tasks described herein. Since witness S is able to see user P performing interactive task 610, witness S may verify the facial identity of user P, and also verify that user P is properly performing interactive task 610, and in real-time. In some embodiments, instructions for interactive task 610 may be provided by witness S, whereby witness S achieves further trust that user P is real and is live performing interactive task 610. Accordingly, witness S may indicate the trust to application 60 running on witness device 300, which sends a message 6504 (e.g., including authentication results 6032) indicating that user P is who they say they are, and including associative code 1213. Message 6504 can also include further evidence of the witnessed authentication of user P, such as by including movements of witness S following actions of user P.

As user P performs interactive task 610, application 60 running on root device 200 collects movement data 651 of user P (e.g., movement data of the head, face, eye, and/or other one or more body parts of the user) that is performing interactive task 610, and invokes root device 200 at intervals (e.g., regular time intervals) to authenticate (e.g., using facial and/or other user recognition routines) user P to root device 200 to generate authentication results 603. Application 60 then sends movement data 651 and authentication results 603 in message 6503 to authentication server 100. In some embodiments, movement data 651 comprises both movement data, as well as other data, such as task or other action related data, and/or physiologic data of the user.

Upon receiving messages 6503 and 6504, authentication server 100 determines that message 6504 corresponds to user account 121 based on the included associative code 1213, and then determines whether the authentication is trusted based on authentication results 603 and, where instructions are part of interactive task 610, a comparison of movement data 651 to expected movement to complete interactive task 610 and/or movements of witness S included in message 6504.

Advantageously, witness S can see the face of user P and may thereby determine that user P is who they say they are. When witness S cannot identify user P, witness S indicates the identify failure to authentication server 100 via application 60 for example, such as by responding negatively to witnessing the authentication, or by not responding at all. Accordingly, authentication server 100 is immediately aware of an attempted scam. Further, witness S also sees that user P is moving (e.g., their head, face, eyes, hands, and/or other body part) to perform the interactive task 610, and the corresponding movement data 651 is also delivered to authentication server 100 from root device 200 for evaluation by authentication server 100. Thus, this authentication provides more trust than when using only a known witness to confirm the facial identity of user P.

To ensure anonymity, application 60 running in witness device can use a privacy tool 22 (e.g., the onion router (TOR), and/or similar software), when communicating with authentication server 100. For example, privacy tool 22 can form a communication channel between witness device 300 and authentication server 100 (e.g., via network 20) that encrypts message 6504 and obfuscates traceability, such as by using multiple routers. Accordingly, witness device 300 cannot be traced by authentication server 100 or any nefarious party attempting to intercept the communicated data and therefore witness S remains anonymous to authentication server 100 and third-party server 400 while witnessing authentication of user P. Particularly, a nefarious party intercepting traffic at authentication server 100 cannot trace witness device 300 and learn the identity of witness S. In some embodiments, root device 200 and/or witness device 300 can also establish communication through privacy tool 22 during authentication of user P.

In some embodiments, witness S may control witness device 300 to access a website of authentication server 100 anonymously via privacy tool 22 and can provide associative code 1213 to authentication server 100 in a spread-spectrum fashion. For example, rather than including associative code 1213 as a single value in message 6504, associative code 1213 can be encrypted and broken into parts that are delivered to authentication server 100 at different times. Authentication server 100 then reassembles received parts and decrypts them to determine associative code 1213, and thereby the corresponding user account 121.

Since both user P and witness S have visual and/or audio communication and are known to one another (e.g., friends, family, and the like) they may each visually and/or audibly identify each other, stopping any authentication if the other party is not as expected. Associative code 1213 can be generated and distributed in a way that is difficult to copy or scam from communications. For example, associative code 1213 can be dispersed within communications in a way that only authentication application 60 and authentication server 100 are aware of and thus a nefarious party would find it difficult, if not impossible, to detect and assemble associative code 1213.

Since authentication server 100 receives movement data 651 corresponding to movements of user P, authentication server 100 can determine when bio-behavioral characteristics in the movement data do not match previously captured bio-behavioral characteristics of user P. In some embodiments, more than one witness can be used to provide additional trust in the authentication of user P. For example, two different witness devices 300 of two different witnesses S at different locations may be selected and used simultaneously to provide two independent witness reports of user P being authenticated by root device 200.

In another example, witness S may instruct, via the video call, to switch to another device, that witness S knows (since they are personally acquainted) user P has, thereby witness S may use personal knowledge of user P to verify that user P is who they say they are. In another example, using application 60, witness S may cause a selection of images to be displayed on display 253 of root device 200, where one image is known to user P (e.g., a picture and/or other visual image of a mutual friend, animal, vehicle, house, slogan, and the like), whereby user P directs their gaze, or otherwise causes a cursor to move to select, that image. Since this particular image is only known to user P, witness S may confirm that user P is who they say they are and not an imposter. In some embodiments, the image can be prearranged between witness S and user P, and other images can be randomly selected from a stock set by application 60 and/or authentication server 100. In another example, witness S and user P can prearrange a certain action or actions restriction, such as limiting cursor movement to a right side of interactive task 610, such that cursor movement can indicate whether user P is not who they say they are. Such pre-agreed responses by user P and witness S may occur without the nefarious party learning what information is being used and evaluated. Accordingly, even if the nefarious party obtains root device 200, the nefarious party will be discovered by witness S.

In some embodiments, user P may wear a device that accurately tracks user movement (e.g., eye movement, head movement, and/or other body part movement) relative to displayed content such that witness S sees, on display 353, what user P is looking at. Thus, user P may not specifically select one image over another but may focus on it for an extended period of time (e.g., glance at it longer). Since witness S sees the associated movement (e.g., eye movement), witness S can tell which image (e.g., picture, icon, or the like) is of more interest to user P. Accordingly, such actions are very difficult for the nefarious party to intercept, learn, and replicate.

In some embodiments, authentication server 100 can receive (e.g., in message 6504), non-identifying data regarding user P and/or witness S. Non-identifying data (also referred to herein as “non-identifying evidence”) can comprise data that does not positively identify a person, but that potentially can be used to rule out one or more individuals as being the user or witness to be authenticated.

In some embodiments, authentication server 100 can receive (e.g., in message 6504) a biometric signature (e.g., breathing patterns, PPG data, blood glucose data, EKG data, EEG and/or other brain activity data; blood pressure data, respiration data; and/or other physiologic information that comprises identifying and/or non-identifying data) of user P from root device 200 and/or of witness S from witness device 300. This biometric signature can be compared to a previously stored biometric signature of user P and/or witness S, respectively. In some embodiments, the biometric signature can be used to identify (e.g., positively identify) the associated user P and/or witness S. In other embodiments, the biometric signature comprises non-identifying data that does not definitively identify user P and/or witness S, but it potentially does allow authentication server 100 to determine when another person may be impersonating user P and/or witness S (e.g., when the recently recorded and previously stored biometric signatures do not sufficiently match, thus indicating it is not the same person). Replay of the biometric signature may also be detected by requiring user P and/or witness S to take certain actions (e.g., coughing, holding of breath, and the like) during capture of the biometric signature, whereby authentication server 100 can detect presence or absence of the requested action in the biometric signature.

In some embodiments, authentication server 100 can receive (e.g., in message 6504) captured non-identifying movement data (e.g., facial expressions, head, eye, hand, and/or other body part movement, reaction times, speed of movement, and the like) of user P and/or witness S from root device 200 and/or witness device 300, respectively. This movement data can be compared to a previously stored movement data 651 of user P and/or movement data 652 of witness S. For example, by detecting certain characteristics in the movement data, authentication server 100 can determine when another person may be impersonating user P and/or witness S (e.g., when certain characteristics do not match, and/or are missing).

In some embodiments, it can be advantageous for user P to ask a second witness to confirm the identify of witness S. For example, the second witness may interact with and recognize witness S and provide confirmation to authentication server 100, providing a corresponding associative code (e.g., an associative code 1213 of a second witness device 300) such that the second witness remains anonymous to authentication server 100 (and to third-party server 400). Particularly, the three parties (user P, witness S, and the second witness) can be known to each other and can readily detect any imposters.

In some embodiments, a user (e.g., user P and/or user S described herein) may wear virtual reality (VR) equipment to view a virtual site generated by software of application 60 that is updated with scenes or challenges generated by authentication server 100 and/or third-party server 400. As described hereinabove, via application 60, user P may be instructed to take certain actions (e.g., to look/scroll up to find a specified number or letter) or to move an object in the VR environment, to move a cursor using movement (e.g., facial, head, eye, hand, and/or other body part movements), or to simply type and/or speak a response. The anonymous witness S may confirm witnessing the movement of user P (e.g., viewed in person or on the witness device 300 when remote) by either following the actions or by inputting a confirmation (e.g., typing and/or speaking). Since the witness S is not limited to moving a cursor via their movements, the witness may type or speak a response, and their captured movements can be evaluated by one or more bio behavioral algorithms of authentication server 100 to confirm authenticity of witness S.

Particularly, captured movements of user P (e.g., head, facial, eye, and/or other body part movements) can be evaluated to determine consistency with the requested actions that take place in VR environment and with movements and/or confirmation provided by witness S. In some embodiments, witness S may provide instructions to user P. For example, user P may be instructed by witness S to look at a particular icon, such as the number three, which can be positioned in a particular screen location, such as at the top right corner of display 253 of root device 200. Authentication server 100 receives data indicative of the icon selected, confirmation of the selected icon from witness S, and movement data indicative of one or both movements of user P and witness S. When authentication server 100 confirms that all data corresponds to the expected actions, and that user P successfully authenticated the root device 200, authentication server 100 can determine that the authentication was successfully witnessed and that trust in user P being who they claim to be is increased. Further, witness S can also confirm (e.g., by responding ‘yes’ to a question presented by application 60) that they confirm the identity of user P, such as after they have viewed and/or spoken with user P.

When witness S is remote from user P, witness S may follow actions (e.g., cursor movements) of user P on display 353 of witness device 300. To control a cursor, for example, user P may make head, eye, hand, and/or other body part movements that are detected by root device 200 and used to move a cursor (e.g., cursor 6001 and/or 6003 described herein). As witness S follows the cursor movement on display 353, movements (e.g., head, eye, hand, and/or other both part movements) made by witness S are captured by witness device 300. Accordingly, the captured movements of user P and witness S are similar, whereby authentication server 100 can compare these movements to one another and to expected movements corresponding to the interactive task. These movements, although captured by sensors capable of biometric identification, may not include biometric information sufficient to positively identify (authenticate) either of user P or witness S. However, while capturing movement of user P, root device 200 can authenticate user P at least once, and witness device 300 can authenticate witness S at least once.

In some embodiments, application 60 running on each root client device 200 and witness device 300, accesses and manipulates a virtual world (e.g., via a website generated by authentication server 100, or third-party server 400), and make actions in that world. Where witness S sees both user P (e.g., via the video call) and actions in the virtual world, witness S can confirm that user P is who they say they are.

As described herein, authentication software 600 can be configured to evaluate behavioral biometric data to identify (“authenticate” herein) user P. The authentication routines of the present inventive concepts performed by authentication software 600 can utilize various biometric data analysis techniques (e.g., including AI algorithm techniques) to authorize a user P (e.g., comprising one or more individuals) to: perform a transaction (e.g., a financial transaction, such as a financial transaction at a level of one thousand dollars or above); gain access to information (e.g., confidential information of a government agency, a corporation, and/or other third party); change a password and/or a unique identification; perform any task of high importance; and/or otherwise be enabled to perform a task that requires authentication of user P.

As described herein, system 10 can be configured to authenticate a user P comprising one or more individuals that are part of a “meta world” environment, such as an authentication involved in a meta world transaction and/or other action (e.g., a transaction and/or other action of high importance as described herein). System 10 can prevent or at least deter (e.g., make it more difficult) for a nefarious party to impersonate one or more users of a group of users of system 10 in a meta world.

System 10 can be configured to improve the reliability of an authentication of a user that currently is accomplished via a website that simply sends a confirmation code to the user's phone or email. The use of the witness client devices of the present inventive concepts as described herein provides additional levels of trust that may be desired or necessary for certain financial transactions or other actions of high importance requiring high-level authentication of one or more individuals. In some embodiments, system 10 enables multiple individuals (e.g., a witness S comprising multiple people) to authenticate a single individual (user P), for example in a meta world. In some embodiments, various members of a group of individuals can authenticate each other, for example such that each member of the group is authenticated by at least two other members of the group. Group members can identify each other based on movements, key phrases, and/or other identifiers as described herein. A group of authenticated users can provide additional authentication to a particular user to authorize a transaction, such as a financial transaction, password change, access to confidential information (e.g., confidential digital files), and/or any one, two, three, or more actions of high importance as described herein. In some embodiments, one or more members of the group remains anonymous to one or more other members of the group and/or to a third-party entity (e.g., a third-party entity requesting the authentication). For example, the user P being authenticated can remain anonymous to the third-party entity, and/or a witness S authenticating the user P can remain anonymous to the third-party entity. Anonymity of either or both user P and/or witness S can be used to prevent a subsequent malicious act by a nefarious party (e.g., to greatly reduce the risk of impersonation of that person and/or theft of that person's cell phone or other device including identifying information).

In some embodiments, third-party server 400 sends a request (e.g., request 602) to authentication server 100, and authentication server 100 sends a code (e.g., task code 81) to root device 200. The code can then be transferred to witness device 300, such as via Bluetooth, such that witness device 300 can register with authentication server 100 by providing the code. After witness device 300 is registered with authentication server 100, a call (e.g., a video call) can be established between root device 200 and witness device 300, such that user P and witness S can authenticate each other, such as to provide authentication to third-party 3P (e.g., to validate a wire transfer and/or a password change). In some embodiments, behavioral biometrics such as voice impediments or other vocal features, facial movements, eye movements, eye blinks (e.g., eye blink patterns), limb and/or digit movements, and/or reaction times of any of these, can be tracked by system 10 (e.g., during a standard call or video call). Behavioral biometrics can be assessed by system 10 to further authenticate user P and/or witness S. In some embodiments, system 10 receives information regarding user P and/or witness S that is used in a training procedure of an AI algorithm of system 10 (e.g., an algorithm of application 60), such as to authenticate user P and/or witness S via at least an AI algorithm.

In some embodiments, system 10 includes an algorithm (e.g., an algorithm of application 60), such as an AI algorithm, that evaluates data collected by one or more sensors of a client device 200 and/or 300 (e.g., one or more motion sensors, physiologic sensors, and/or imaging sensors) to authenticate the user P of root device 200. For example, system 10 can evaluate the habits of user P (e.g., how root device 200 is manipulated by the user P during regular use), and can compare that evaluation data to data collected during an authentication to confirm user P is the user of root device 200.

In some embodiments, authentication server 100 provides a code to both user P and witness S, as well as information for the creation of a numeric input display for user P and witness S to view and enter the code (e.g., on a screen of their associated client devices 200 and/or 300). The input display provided to user P (e.g., to be displayed on root device 200) can be different than the display provided to witness S (e.g., to be displayed on witness device 300). For example, the display provided to user P can comprise a “number pad” (e.g., three rows of three numbers with the number 1 in the bottom left and the number nine in the top right), and the display provided to witness S can comprise a “phone keypad” display (e.g., three rows of three numbers, with the number one in the top right, and the number nine in the bottom right). Authentication server 100 can be configured to analyze both the code input by user P and/or witness S and at what location on client devices 200 and/or 300 was each digit input, such as to provide an additional level of trust. In some embodiments, the code is entered via eye-tracking or other body part movement, such that user P and/or witness S enters the code by looking at or otherwise moving relative to the digits displayed on client devices 200 and/or 300.

In some embodiments, user P and/or witness S are authenticated (e.g., via facial recognition or other routine described herein) by client devices 200 and/or 300 at regular intervals (e.g., semi-continuously) during an authentication process. In some embodiments, facial recognition is performed along with motion tracking (e.g., eye tracking), such that as a user enters a code (e.g., via motions, such as eye tracking), while the user is further authenticated (e.g., simultaneously authenticated) via facial recognition. The eye or other body part motion tracking can also be correlated to the layout of the numbers displayed to the user.

In some embodiments, user P can move a cursor displayed on root device 200 to a location of a desired icon (e.g., a number), such as to enter an authentication code. The user can move the cursor with eye movement (e.g., via eye tracking enabled by a client device 200 and/or 300) and/or via head, facial, and/or other body part. While the cursor is being manipulated by the user's movements, system 10 can perform facial recognition (e.g., multiple times, such as by continuously and/or intermittently performing multiple facial recognitions). In some embodiments, system 10 also performs (e.g., continuously and/or intermittently performs) behavioral biometric authentication of the user, such as while an authentication code is being input to a client device 200 and/or 300, such as by monitoring facial movement, head movement, blinking, and/or other body part movement and assessing the movement multiple times (e.g., at equal intervals of time).

In some embodiments, a third-party requiring authentication of a user (e.g., a bank) sends out multiple sets of data (e.g., comprising pictures, numbers, and/or other data) to different individuals (e.g., to at least one user P and at least one witness S). Based on the motion of each user P and/or witness S via an associated client device 200 and/or 300, the third party can differentiate these individuals based on body part motions performed by each and the associated set of data sent to each. In these embodiments, the third party may not receive any images (e.g., facial or other identifying images) of one or more (e.g., all) of the individuals receiving the sets of data (e.g., authenticated via the sets of data or otherwise).

In some embodiments, system 10 is configured to authenticate a user P to a third party, using a witness S, where either the user P, the witness S, or both, remain anonymous (e.g., to each other, and/or to the third party receiving the authentication). Various identification data can be gathered from user P and/or witness S, such as is described herein. An anonymous individual (e.g., either or both user P or witness S) can receive a code to be used for confirmation, also as described herein. In some embodiments, a physiologic parameter of an individual is taken (e.g., a PPG reading taken via a sensor of a client device 200 and/or 300) while an image (e.g., a facial image) of the individual is simultaneously created, each providing data used for authentication. In some embodiments, a web-meeting is used in the authentication of an event (e.g., a wire transfer of money and/or confidential information), where a first individual could confirm the identity of a second, while the first individual, the second individual, or both, remain anonymous (e.g., to the third party).

In some embodiments, system 10 can be configured to present a set of images (e.g., dozens of images can be displayed) to user P and witness S, where one or more of the images are familiar to these individuals, and one or more of the images are not familiar. User P and witness S can each select the familiar images, confirming a familiarity (e.g., known relationship) between user P and witness S. In some embodiments, images are displayed to user P and/or witness S in a meta world environment, such as a virtual and/or augmented reality environment. In some embodiments, images can be selected by these individuals by focusing their attention (e.g., eye gaze) on the familiar images and/or otherwise selecting the familiar images.

In some embodiments, an authentication performed by system 10 can occur in a meta world, such as when user P and witness S are virtually represented by respective avatars. In some embodiments, the avatar of witness S can be displayed to user P in a familiar way and displayed to any third-party users as an anonymous avatar, such that witness S can remain anonymous.

In some embodiments, authentication server 100 is configured to protect the identity of witness S from a third party (e.g., not sending the information to third-party server 400), for example by providing that all communications between witness device 300 and third-party server 400, do not include the actual identity of witness S.

In some embodiments, authentication server 100 uses a “spread spectrum code”, where a portion of the authentication code is delivered to user P and a portion is delivered to witness S (e.g., one or more witnesses S). User P and witness S (e.g., at least two individuals) combine the code and return the complete code to authentication server 100 (e.g., via a client device 200 and/or 300) to authenticate user P. In some embodiments the spread spectrum code is presented to these individuals as various images, numerals, and/or other identifiable data. In some embodiments the code is presented to the individuals in a meta world.

In some embodiments, one or more client devices 200 and/or 300 (e.g., at least one of root device 200 and/or witness device 300) comprises a virtual and/or augmented reality device, such as a Microsoft HoloLens and/or a Meta Oculus.

In some embodiments, one or more client devices 200 and/or 300 (e.g., at least one of root device 200 and/or witness device 300) is configured to perform a retinal scan. In these embodiments, the client device 200 and/or 300 can be configured to perform other biometric identification of user P and/or witness S.

In some embodiments, authentication server 100 is configured to authenticate a user P by matching a unique facial ID with one or more other biometric identifiers (e.g., one or more behavioral biometric identifiers, such as a behavioral identifier found by measuring facial movement and/or eye movement).

In some embodiments, some user P identifying information (e.g., a retinal scan) remains local to the user P (e.g., on root device 200), and other identifying information, for example behavioral information such as facial movement information, is transmitted to authentication server 100. A client device 200 and/or 300 can confirm to authentication server 100 that the retinal scan matches the intended user (e.g., without actually sending the retinal scan information), and authentication server 100 can confirm that the behavioral information that is received by server 100 matches the user P.

In some embodiments, authentication server 100 provides a virtual maze or other puzzle to a group of individuals in a meta world, where clues to solving the puzzle are presented to the individuals (e.g., as familiar sounds or objects, for example information that is familiar to the group of individuals but would otherwise seem random to an imposter). In some embodiments, the puzzle is generated by an AI algorithm. Biometric data (e.g., behavioral biometric data) and/or other authentication data can be collected by system 10 from the individuals while the puzzle is being solved (e.g., via their associated client devices 200 and/or 300). In some embodiments, an algorithm, such as an AI algorithm, analyzes the data collected (e.g., at least behavioral biometric data) to detect an imposter is present within the group (e.g., an imposter identification performed as the puzzle is solved). Once the puzzle is solved, if no imposter was identified, each member of the group of individuals are then considered authenticated by system 10. Each individual can be classified as a user P, a witness S, or both.

In some embodiments, interactive task 610 comprises a virtual maze presented to user P and/or witness S (e.g., a maze presented in a virtual reality and/or augmented reality manner). In some embodiments, interactive task 610 can provide access to a virtual meeting or other virtual collective, such that once the maze is completed, the users can communicate privately and/or securely (e.g., transfer information privately and/or securely), knowing that all members of the virtual collective have properly completed the maze. The maze can include multiple passageways (e.g., multiple doors to select or hallways to choose from), where the passageways are adorned with various images. Images and/or groups of images presented throughout the maze can indicate to the various users which passageways to select to complete the maze. For example, groups of images can “make sense” to the users, that would otherwise be meaningless to a nefarious party. In some embodiments, authentication server 100 is configured to analyze behavioral biometric data recorded as the users complete interactive task 610, for example to determine if a user is spending an unacceptable amount of time to “figure out” the maze, which may indicate the user is a nefarious party attempting to infiltrate the virtual collective. In some embodiments, algorithm 15 of system 10 comprises an AI algorithm that analyzes the behavioral biometric data, such as to determine if a user is attempting to figure out the maze, or if the user is clearly understanding the task, for example clearly recognizing the correlations between the images displayed (e.g., as a known user would recognize).

In some embodiments, system 10 is configured to perform an authentication of a user P based on information gathered from a witness identification, behavioral biometric data, biometric data (e.g., fingerprint data), physiologic data, and combinations of these. In some embodiments, authentication server 100 stores various types of information related to a user P (e.g., ID information 650), where a single piece of ID information 650 of a single type is insufficient to identify a user (e.g., a portion of a fingerprint, and/or a portion of recorded behavioral biometric data). System 10 can be configured to use multiple types of recorded ID information 650 (e.g., information recorded during an authentication process compared to information previously recorded to identify user P) to perform an identification of user P, such that no complete identifying piece of information is transferred between user P and authentication server 100 (e.g., no complete identifier is transferred between user device 200 and authentication server 100). For example, a portion of a fingerprint, and a portion of a behavioral biometric recording, each insufficient to identify user P, can be used by authentication server 100 in combination to authenticate the user.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1-16. (canceled)

17. A system for authenticating a user, comprising:
a software product comprising instructions, stored on computer-readable media, wherein the instructions, when executed by a computer, perform steps for witnessing authentication of the user of a user device by a witness using a secondary device, the software product comprising:
a first computer-readable media in the user device, comprising at least one of:
instructions for receiving a task code from an authentication server;
instructions for generating, for display by the user device and based upon the task code, a first part of a virtual screen defining an interactive task implemented by both the user device and the secondary device;
instructions for synchronizing the interactive task with a secondary device;
instructions for invoking biometric authentication of the user by the user device to generate an authentication result;
instructions for capturing first movement data detected by the user device as the user performs the interactive task; or
instructions for sending the authentication result and the first movement data to the authentication server; and
a second computer-readable media in the secondary device, comprising at least one of:
instructions for receiving the task code from one of the authentication server or the user device;
instructions for generating, for display by the secondary device and based upon the task code, at least part of the virtual screen of the interactive task implemented by both the user device and the secondary device;
instructions for synchronizing the interactive task with the user device;
instructions for capturing second movement data detected by the secondary device as the user performs the interactive task; or
instructions for sending the second movement data to the authentication server,
wherein the system is configured to authenticate the user to perform an action of high importance.

18. The system of claim 17, further comprising a third computer-readable media in an authentication server, comprising at least one of:
instructions for generating the task code defining the interactive task and expected movement;
instructions for sending the task code to the user device;
instructions for receiving the authentication result and the first movement data from the user device;
instructions for receiving the second movement data from the secondary device;
instructions for analyzing the first movement data, the second movement data, and the expected movement to determine whether the first movement data, the second movement data, and the expected movement match; or
instructions for determining success of the witnessing authentication when the authentication result indicates successful biometric authentication of the user to the user device and the first movement data, the second movement data, and the expected movement match.

19. The system of claim 17, wherein the action of high importance comprises an action selected from the group consisting of: performing a financial transaction; gaining access to information; changing a password or a unique identification; transferring of power or authority; making a medical decision; making a military action decision; making a police action decision; making a crisis intervention decision; making a governmental decision; and combinations thereof.

20. The system of claim 19, wherein the action of high importance comprises two or more actions of high importance.

21. The system of claim 17, further comprising an algorithm configured to authenticate the user.

22. The system of claim 21, wherein the algorithm comprises a bias configured to cause the authentication to tend away from a false authentication.

23. The system of claim 17, wherein the system is configured to randomly generate a task code defining the interactive task.

24. The system of claim 17, wherein the first movement data and the second movement data each comprise head, facial, hand, and/or other movement data captured by respective ones of the user device and the secondary device without including identifying biometric information.

25. The system of claim 17, wherein the system comprises the user device including a first screen and the secondary device including a second screen, wherein the system further comprises a virtual screen comprising the first screen and the second screen, and wherein the system is configured to authenticate the user by the user successfully completing the interactive task on the virtual screen.

26. The system of claim 25, wherein the interactive task comprises one or more of: a maze puzzle task; a sequence of facial, hand, and/or other body part movement tasks provided visually and/or audibly; or a series of tasks comprising consecutive non-repeating single digit numbers.

27. The system of claim 25, wherein the interactive task comprises one or more tasks that include control of a cursor, icon, and/or other graphic on the virtual screen via head, facial, eye, hand, and/or other body part movement of the user.

28. The system of claim 17, wherein the system is further configured to transfer a code from the authentication server to the user, and wherein the code is transferred in two or more segments.

29. The system of claim 28, wherein at least one of the two or more segments of the code is transferred to the witness, and wherein the witness transfers the at least one of the two or more segments of the code to the user.

30. The system of claim 17, wherein the interactive task comprises a maze that is configured to be presented to the user in a virtual world.

31. The system of claim 17, wherein the witness comprises an anonymous witness.

32. The system of claim 31, wherein the anonymous witness is known to the user, and wherein the system is configured to register the anonymous witness to the user.
